(19) United States
(12) Patent Application Publication
(10) Pub. No.: US 2013/0033653 A1
(43) Pub. Date: Feb. 7, 2013

(54) LIQUID CRYSTAL DISPLAY DEVICE

(71) Applicants: Takato HIRATSUKA, Chiba (JP); Osamu Itou, Hitachi (JP)

(72) Inventors: Takato HIRATSUKA, Chiba (JP); Osamu Itou, Hitachi (JP)

(73) Assignee: Japan Display East Inc.

(21) Appl. No.: 13/562,401

(22) Filed: Jul. 31, 2012

(30) Foreign Application Priority Data
Aug. 5, 2011 (JP) 2011-171819

(51) Int. Cl. G02F 1/1343

(52) U.S. Cl. 349/38

(57) ABSTRACT

There is provided a liquid crystal display device including a first capacitive electrode and a second capacitive electrode. Among the capacitive electrodes, a side edge portion of the first capacitive electrode formed in a level, which is closer to the liquid crystal layer, on the side of the pixel display portion is formed so as to be further retreated than a side edge portion of the second capacitive electrode formed in a level, which is further from the liquid crystal layer, on the side of the pixel display portion. A second convex formed in a region overlapping with a corner and a side edge portion of the retreating region or a region between a side edge portion of the retreating region and the other capacitive electrode and extending in a shorter-side direction of the pixel is further provided.

### CROSS-REFERENCE TO RELATED APPLICATION

The present application claims priority from Japanese application JP2011-171819 filed on Aug. 5, 2011, the contents of which are hereby incorporated by reference into this application.

### BACKGROUND OF THE INVENTION

1. Field of the Invention

The present invention relates to a liquid crystal display device, and particularly to a technique for suppressing reverse twist occurring in each pixel.

2. Description of the Related Art

In recent years, performances of liquid crystal display devices have been enhanced, and liquid crystal display device products with small or medium sizes ranging from three to four inches which are capable of performing WVGA display supporting 800×480 pixels have been required. In each of such liquid crystal display panels with small or medium sizes capable of performing WVGA display, however, it is necessary to form a plurality of display pixels (hereinafter, referred to as pixels) within a limited display region, and therefore, one pixel width is about 30 μm. For this reason, it has been required to further enhance an aperture ratio and a display mode efficiency.

As a liquid crystal display device with an enhanced display mode efficiency, a liquid crystal display device is known in which a pair of electrodes are formed at side edge portions on the long sides of a pixel region and the electrodes are formed as so-called wall-shaped electrodes protruding from a surface of a substrate toward the inside of a liquid crystal layer. The liquid crystal display device is configured so as to generate an electric field parallel to a main surface of a liquid crystal display panel (so-called lateral electric field) and drive liquid crystal molecules by supplying a video signal to one wall-shaped electrode (pixel electrode) and supplying a reference common signal to the other wall-shaped electrode (common electrode). Since electrodes cannot be formed in a region between the pixel electrode and the common electrode in the liquid crystal display device with the above configuration, electrodes as retentive capacitors are formed along shorter side portions of the pixel region.

On the other hand, a liquid crystal display device as disclosed in Patent Document 1, for example, is designed such that one pixel region is formed as a region with two or more different inclination angles in order to suppress coloring in display resulting from a variation in view angles, which occurs in a liquid crystal display device based on the lateral electric field scheme. In the liquid crystal display device described in Patent Document 1, linear pixel electrodes and linear common electrodes are alternately arranged via insulating films on a first substrate on which thin film transistors and the like are formed, and the pixel electrodes and the common electrodes are bent and formed into V shapes within the pixel regions. The liquid crystal display device has a multi-domain structure for suppressing coloring in display resulting from a variation in view angles by allowing the liquid crystal molecules to rotate in reverse directions from bent portions of the V shapes as boundaries.

Furthermore, in the liquid crystal display device described in Patent Document 1, not only the V-shaped bent portions of the linear pixel electrodes and the common electrodes but also end portions of the linear pixel electrodes and the common electrodes are also formed into V shapes to suppress the domain occurring at end portions of the pixels.

According to a liquid crystal display device described in JP2007-3877A, a plurality of linear electrodes are arranged in a pixel region, and therefore, an interval between each pixel electrode and each common electrode in the in-plane direction is about 4 μm. On the other hand, the liquid crystal display device using wall-shaped electrodes is designed such that electrodes are arranged at side edge portions of the pixels, and therefore, an interval between each pixel electrode and each common electrode is about 30 μm.

For this reason, a liquid crystal display device based on a wall-shaped electrode scheme has a problem in that occurrence of the domain cannot be suppressed even if V-shaped inclinations are formed at end portions of the pixel electrodes and the common electrodes in the same manner as in JP2007-3877A in order to prevent occurrence of reverse twist of the liquid crystal molecules (hereinafter, simply referred to as a “domain” in this specification) resulting from the formation of the retentive capacitors at the pixel end portions.

In addition, it is possible to reduce the interval between each pixel electrode and each common electrode to be as small as 10 μm, which is about a half, in another configuration of the liquid crystal display device based on the wall-shaped electrode scheme in which linear common electrodes are formed at center portions of the pixels while circular pixel electrodes are formed along the side edge portions of the pixel region. However, since the interval is significantly longer than an interval between a first electrode and a second electrode forming a retentive capacitor, there is a concern in that transmittance is lowered and a display mode efficiency is also lowered to a great extent due to domains occurring at end portions of display portions (pixel display portion, opening portion) of the pixels.

### SUMMARY OF THE INVENTION

An object of the present invention is to provide a technique capable of suppressing domains occurring at end portions of electrodes forming retentive capacitors and improving a display mode efficiency.

(1) In order to achieve the above object, there is provided a liquid crystal display device which includes a first substrate and a second substrate arranged so as to face each other via a liquid layer, the first substrate including video signal lines extending in a Y direction and arranged next to one another in an X direction and scanning signal lines extending in the X direction and arranged next to one another in the Y direction, pixel regions surrounded by the video signal lines and the scanning signal lines being formed in a matrix shape, the liquid crystal display device including: a pair of wall-shaped first electrodes, which are formed along facing longer side edge portions of each pixel, at least a part of which overlaps with a first convex protruding from the first substrate on a side surface of the liquid crystal toward the side of the liquid crystal layer; a linear second electrode which is formed in a pixel display portion interposed between the pair of first electrodes along an extending direction of the first electrodes; a first capacitive electrode which is formed in at least one end portion of the pixel in a longer-side direction so as to be electrically connected to the first electrodes; and a second capacitive electrode which is arranged so as to overlap with the first capacitive electrode via an insulating film and electrically connected to the second electrode, wherein among the capacitive electrodes, a side edge portion of the first capacitive electrode formed in a level, which is closer to the liquid crystal layer, on the side of the pixel display portion is formed so as to be further retreated than a side edge portion of the second capacitive electrode formed in a level, which is further from the liquid crystal layer, on the side of the pixel display portion, and the second capacitive electrode is exposed from a retreating region of the first capacitive electrode in a planar view from the side of the liquid crystal layer, and wherein a second convex is formed in a region overlapping with a corner and a side edge portion of the retreating region or a region between a side edge portion of the retreating region and the other capacitive electrode and extending in a shorter-side direction of the pixel.

(2) In order to achieve the above object, there is provided a liquid crystal display device which includes a first substrate and a second substrate arranged so as to face each other via a liquid crystal layer, the first substrate including video signal lines extending in a Y direction and arranged next to one another in an X direction and scanning signal lines extending in the X direction and arranged next to one another in the Y direction, pixel regions surrounded by the video signal lines and the scanning signal lines being formed in a matrix shape, wherein the first substrate includes: a pair of wall-shaped first electrodes, which are formed along facing longer side edge portions of each pixel, at least a part of which overlaps with a first convex protruding from the first substrate on a side surface of the liquid crystal toward the side of the liquid crystal layer; a linear second electrode which is formed in a pixel display portion interposed between the pair of first electrodes along an extending direction of the first electrodes; a first capacitive electrode which is formed in at least one end portion of the pixel in a longer-side direction so as to be electrically connected to the first electrodes; and a second capacitive electrode which is arranged so as to overlap with the first capacitive electrode via an insulating film and electrically connected to the second electrode, wherein the second substrate includes a linear third electrode formed at a position facing the second electrode via the liquid crystal layer; and a fourth electrode formed in at least one end portion of the pixel in the longer-side direction and electrically connected to the third electrode, wherein among the capacitive electrodes, side edge portions of the first capacitive electrode and the fourth electrode formed in a level, which is closer to the liquid crystal layer, on the side of the pixel display portion are formed so as to be further retreated than a side edge portion of the second capacitive electrode formed in a level, which is further from the liquid crystal layer, on the side of the pixel display portion, and wherein the first substrate is provided with a second convex formed in a region overlapping with a corner and a side edge portion of the retreating region or a region between a side edge portion of the retreating region and the other capacitive electrode and extending in a shorter-side direction of the pixel.

According to the present invention, it is possible to suppress domains occurring at end portions of electrodes forming retentive capacitors and to thereby enhance a display mode efficiency.

Other effects of the present invention will be understood from description of the entire specification.

### BRIEF DESCRIPTION OF THE DRAWINGS

FIG. 1 is a plan view illustrating an overall configuration of a liquid crystal display device according to a first embodiment of the present invention.

FIG. 2 is an enlarged view of a first substrate side for illustrating a pixel configuration in the liquid crystal display device according to the first embodiment of the present invention.

FIG. 3 is a cross-sectional view taken along a line III-III in FIG. 2.

FIG. 4 is an enlarged view illustrating a detailed configuration of an end portion of a pixel in the liquid crystal display device according to the first embodiment of the present invention.

FIG. 5 is a diagram illustrating a detailed configuration of an end portion of a pixel in a liquid crystal display device provided only with wall-shaped pixel electrodes.

FIG. 6 is a cross-sectional view taken along a line VI-VI in

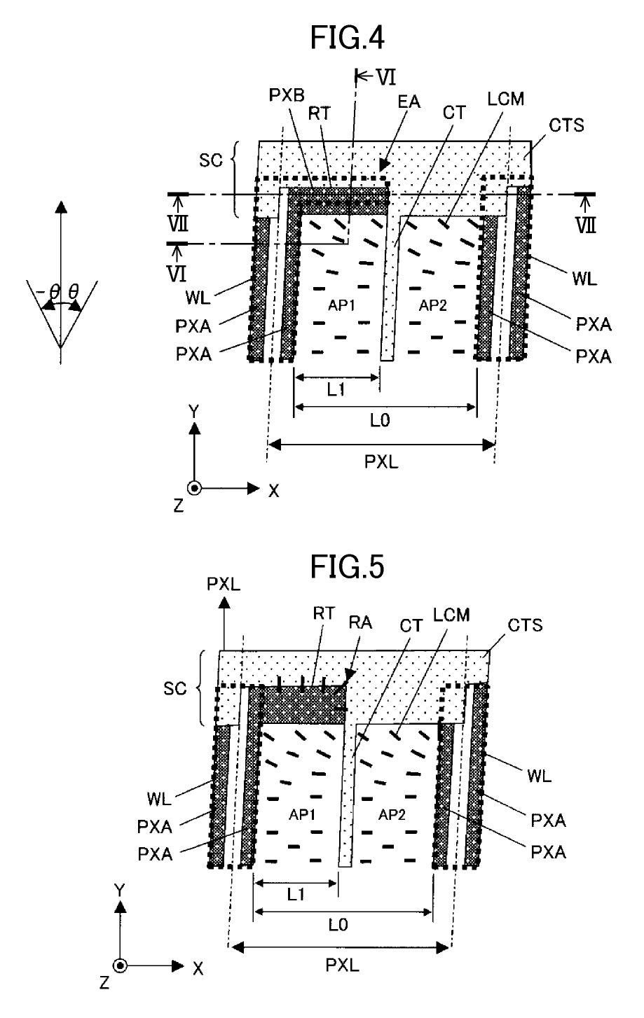

FIG. 4.

FIG. 7 is a cross-sectional view taken along a line VII-VII in FIG. 4.

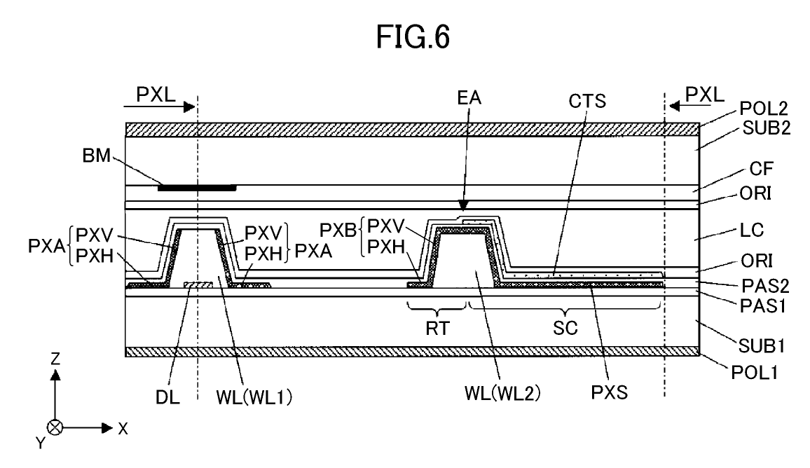

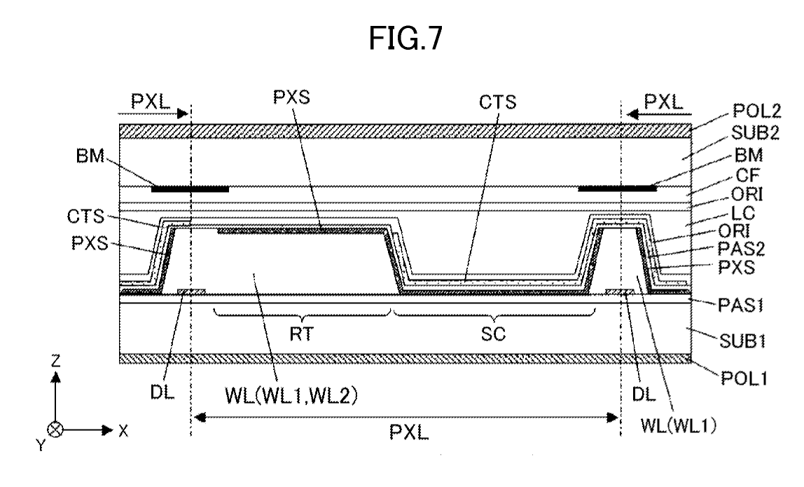

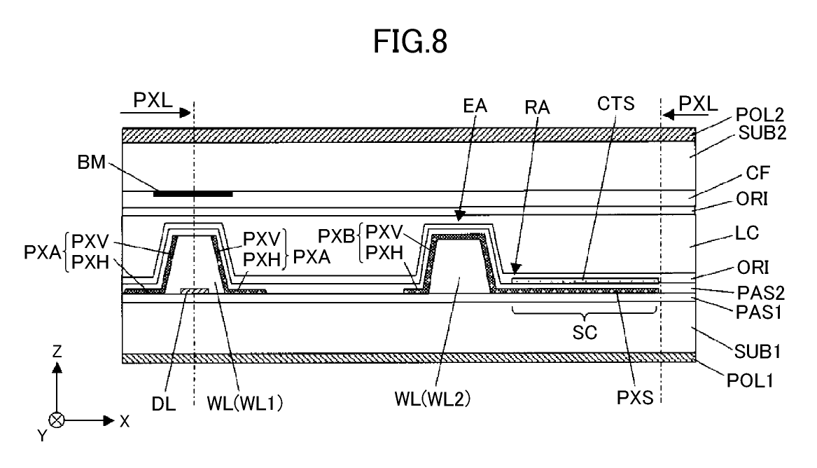

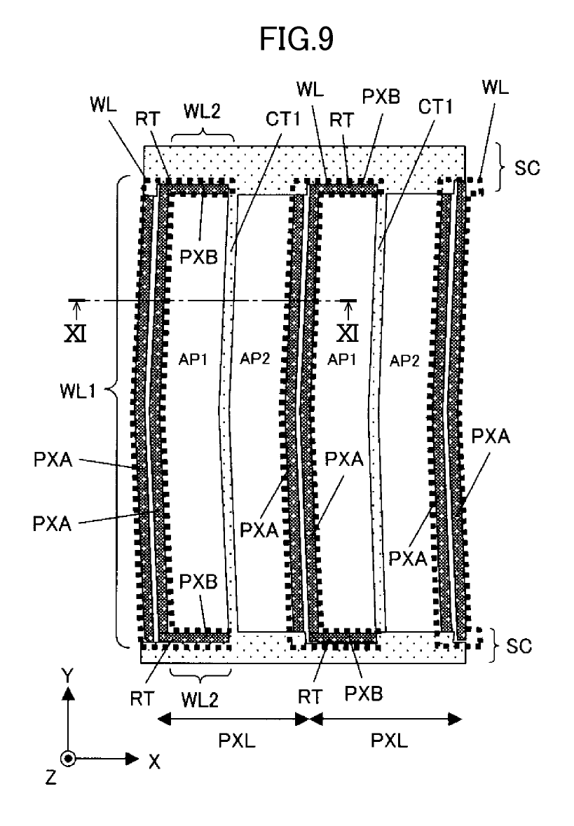

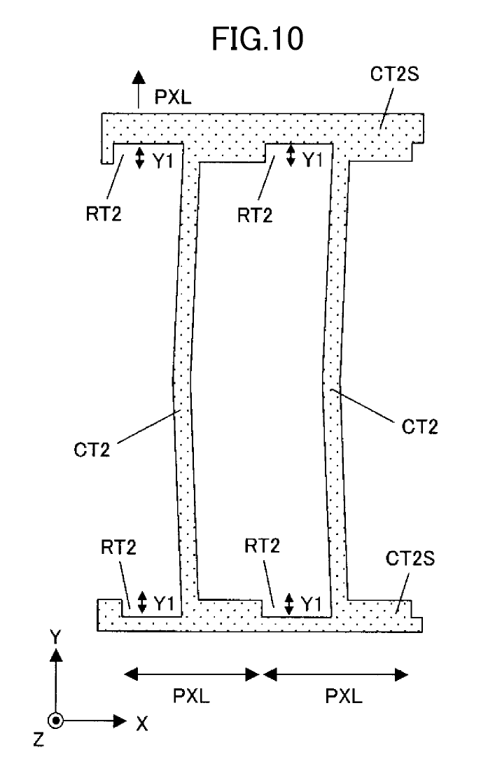

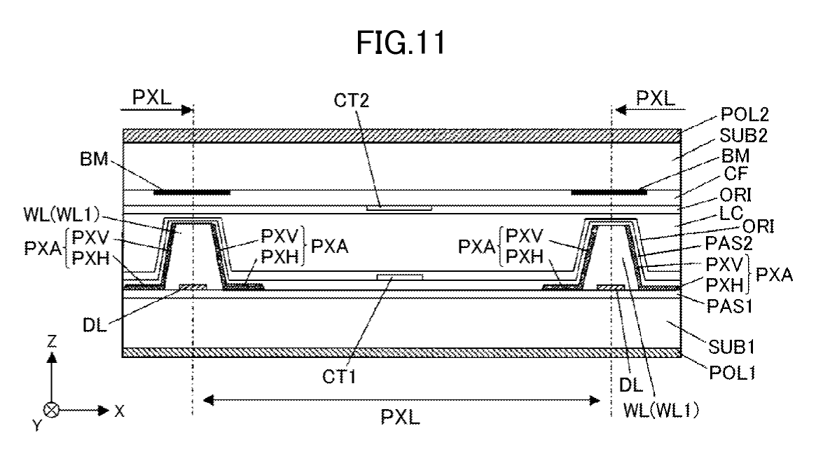

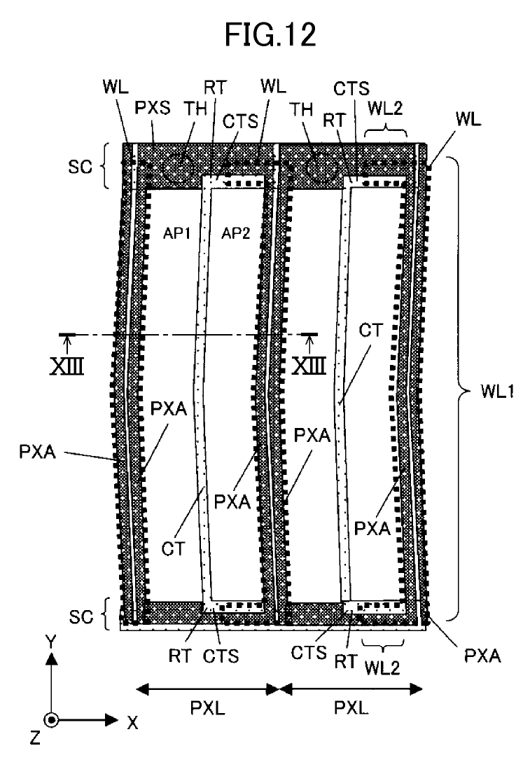

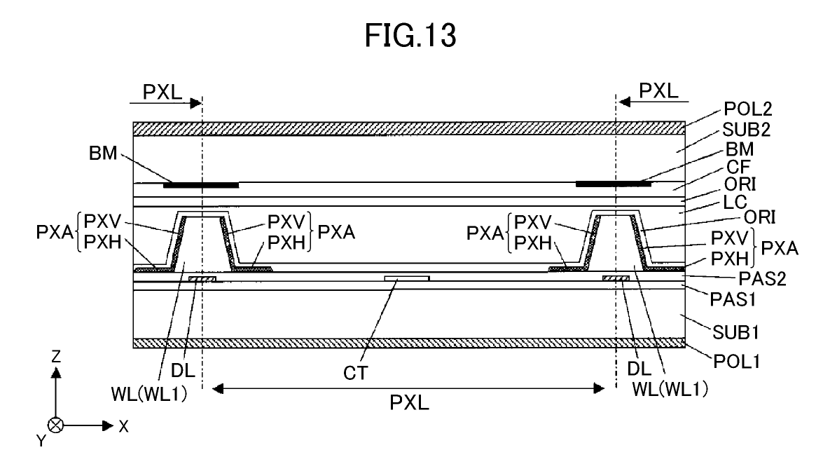

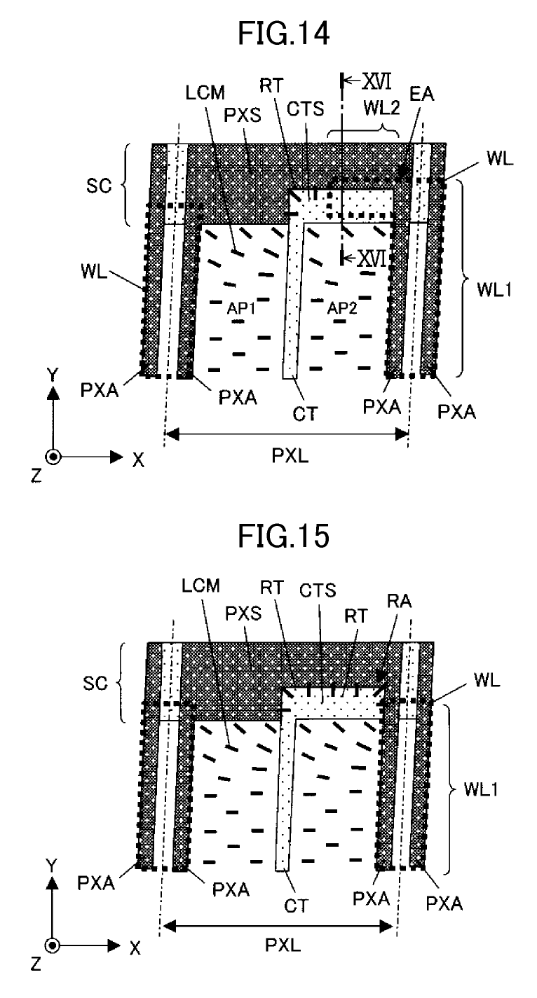

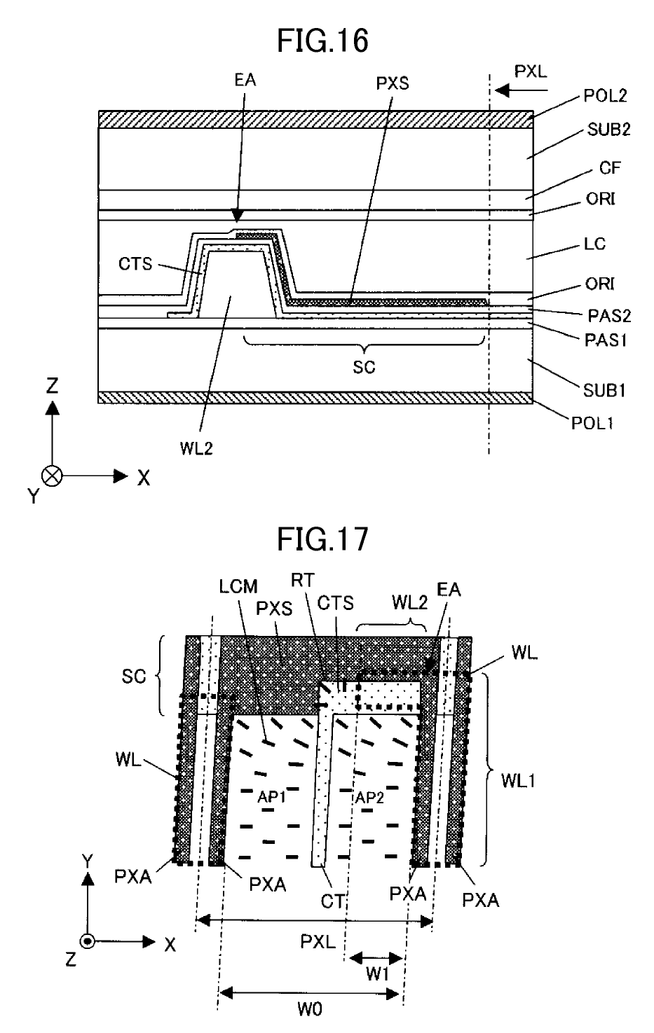

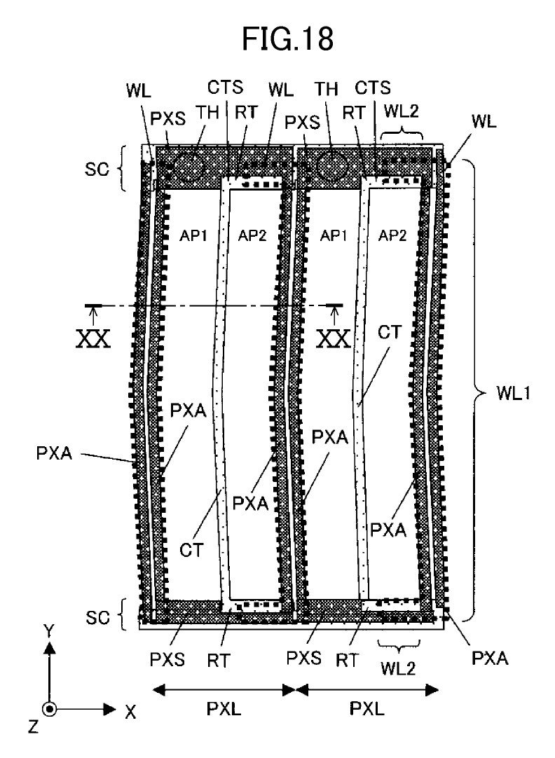

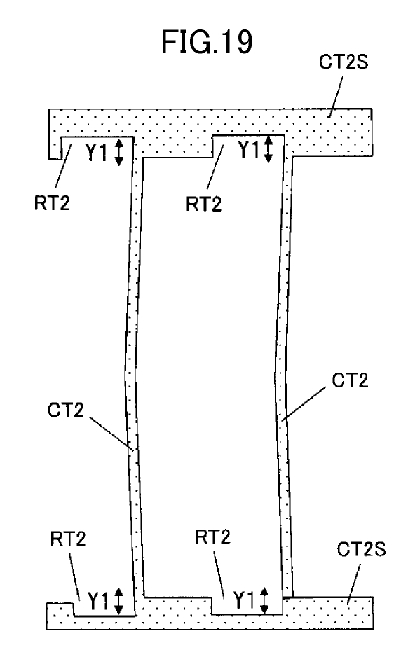

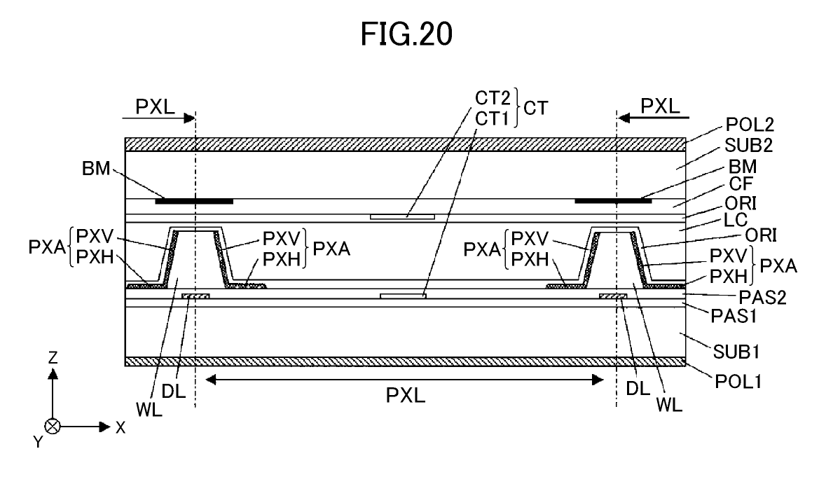

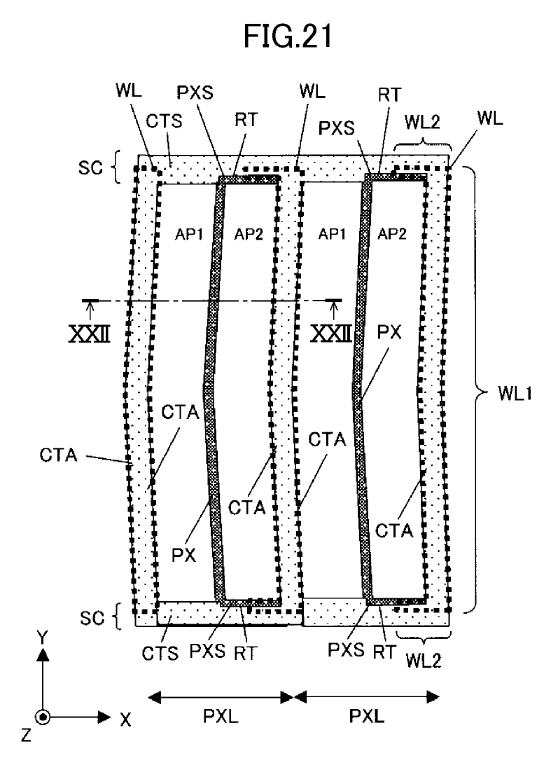

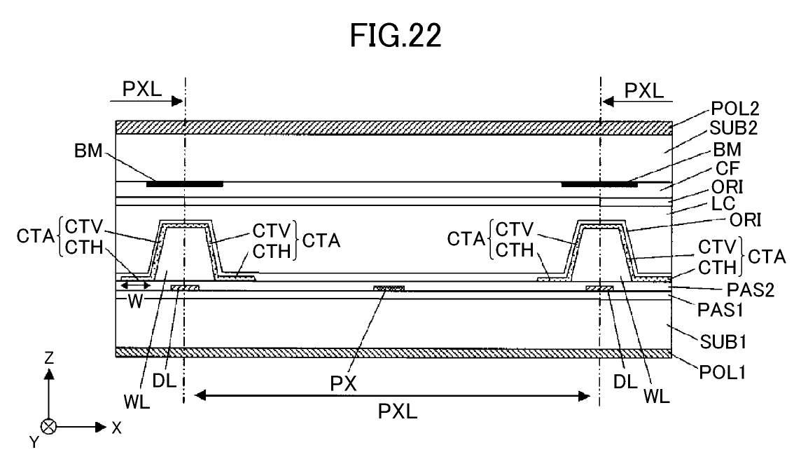

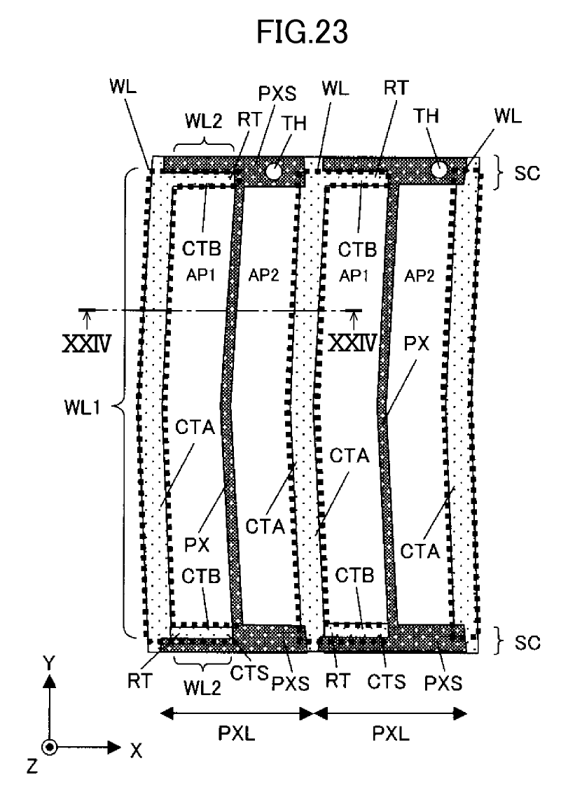

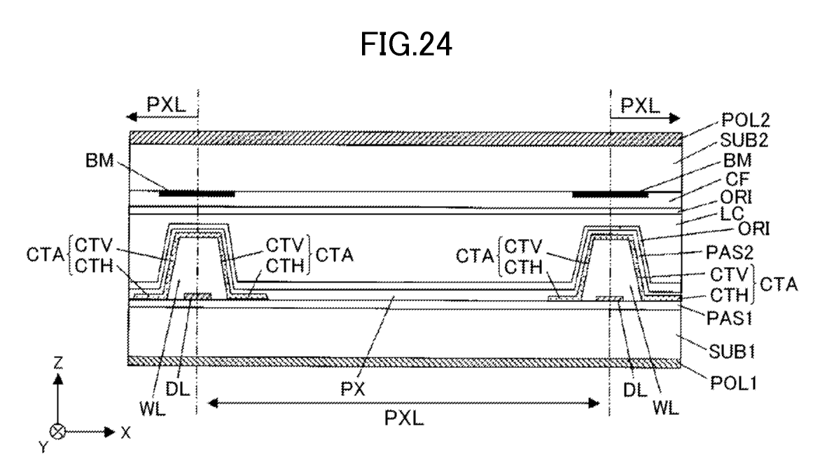

FIG. 8 is a diagram showing another embodiment corresponding to FIG. 6.

FIG. 9 is an enlarged view of a first substrate side for illustrating a pixel configuration of a liquid crystal display device according to a second embodiment of the present invention.

FIG. 10 is an enlarged view of a second substrate side for illustrating the pixel configuration in the liquid crystal display device according to the second embodiment of the present invention.

FIG. 11 is a cross-sectional view taken along a line XI-XI in FIG. 9.

FIG. 12 is an enlarged view of a first substrate side for illustrating a pixel configuration in a liquid crystal display device according to a third embodiment of the present invention.

FIG. 13 is a cross-sectional view taken along a line XIII-XIII in FIG. 12.

FIG. 14 is an enlarged view illustrating a detailed configuration of an end portion of a pixel in the first substrate according to the third embodiment of the present invention.

FIG. 15 is an enlarged view illustrating a detailed configuration of an end portion of a pixel in a first substrate of a liquid crystal display device provided only with wall-shaped pixel electrodes.

FIG. 16 is a cross-sectional view taken along a line XVI-XVI in FIG. 14.

FIG. 17 is an enlarged view illustrating another pixel configuration according to the third embodiment of the present invention.

FIG. 18 is an enlarged view illustrating a pixel configuration in a liquid crystal display device according to a fourth embodiment of the present invention.

FIG. 19 is a diagram schematically illustrating a configuration of a second common electrode in the liquid crystal display device according to the fourth embodiment of the present invention.

FIG. 20 is a cross-sectional view taken along a line XX-XX shown in FIG. 18.

FIG. 21 is an enlarged view showing two pixels for illustrating a pixel configuration in a liquid crystal display device according to a fifth embodiment of the present invention.

FIG. 22 is a cross-sectional view taken along a line XXII-XXII in FIG. 21.

FIG. 23 is an enlarged view illustrating a pixel configuration in a liquid crystal display device according to a sixth embodiment of the present invention.

FIG. 24 is a cross-sectional view taken along a line XXIV-XXIV in FIG. 23.

### DETAILED DESCRIPTION OF THE INVENTION

Hereinafter, description will be given of embodiments, to which the present invention is applied, with reference to the drawings. In the following description, same reference numerals will be given to same components, and the description thereof will not be repeated. In addition, X, Y, and Z represent an X axis, a Y axis, and a Z axis, respectively.

### First Embodiment

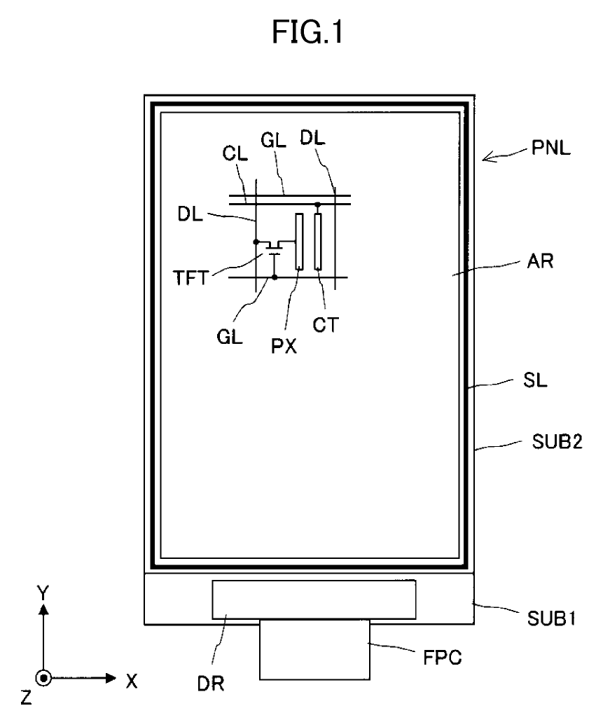

FIG. 1 is a plan view illustrating an overall configuration of a liquid crystal display device according to a first embodiment of the present invention, and hereinafter, description will be given of an overall configuration of the liquid crystal display device according to the first embodiment based on. FIG. 1. In the specification, a display mode efficiency means transmittance obtained by removing an influence of absorption, by a color filter CF and polarizing plates POL1 and POL2, for example, and an influence of an aperture ratio. Accordingly, the display mode efficiency is 100% when a vibration direction of a linear polarization emitted from the polarizing plate POL1 on the side of a backlight unit is rotated by 90° when the linear polarization is incident on the polarizing plate POL2 on the side of a display surface.

As shown in FIG. 1, the liquid crystal display device according to the first embodiment includes a liquid crystal display panel PNL configured by a first substrate SUB1 on which components such as pixel electrodes PX and thin film transistors TFT are formed, a second substrate SUB2, which is arranged so as to face the first substrate SUB1, on which components such as a color filter are formed, and a liquid crystal layer interposed between the first substrate SUB1 and the second substrate SUB2. In addition, the liquid crystal display device is configured by a combination of the liquid crystal display panel PNL and the backlight unit (backlight device), which is not shown in the drawings, as a light source. In the above configuration, a seal member SL circularly applied to a periphery of the substrate 2 performs fixing between the first substrate SUB1 and the second substrate SUB2 and seals the liquid crystal. In the liquid crystal display device according to the first embodiment, however, a region, in which display pixels (hereinafter, abbreviated as pixels) are formed, in the region with the liquid crystal sealed therein corresponds to a display region AR. Therefore, even if a region is in the region with the liquid crystal sealed therein, the region is not a part of the display region AR as long as the region does not have pixels formed therein and is not involved in displaying.

In addition, the second substrate SUB2 has a smaller area than that of the first substrate SUB1 so as to expose a side portion of the first substrate SUB1 on the lower side in FIG. 1. On the side portion of the first substrate SUB1, a drive circuit DR configured by a semiconductor chip is mounted. This drive circuit DR drives each pixel arranged in the display region AR. In the following description, the liquid crystal display panel PNL will be also referred to as a liquid crystal display panel. In addition, although known glass substrates, for example, are typically used as base materials of the first substrate SUB1 and the second substrate SUB2, transparent insulating resin substrates may be also used.

In the liquid crystal display device according to the first embodiment, scanning signal lines (gate lines) GL extending in the X direction and arranged next to one another in the Y direction in FIG. 1, to which scanning signals from the drive circuit DR are supplied, are formed in the display region AR on a surface of the first substrate SUB1 on the side of the liquid crystal. In addition, video signal lines (drain lines) DL extending in the Y direction and arranged next to one another in the X direction in FIG. 1, to which video signals (gradation signals) from the drive circuit DR are supplied, are also formed. A region surrounded by two adjacent drain lines DL and two adjacent gate lines GL configures a pixel, and a plurality of pixels are arranged in a matrix shape in the display region AR along the drain lines DL and the gate lines GL.

Each pixel is provided with a thin film transistor TFT which is turned on and off by a scanning signal from the gate line GL, a pixel electrode PX to which a video signal from the drain line DL is supplied via the thin film transistor TFT in the ON state, and a common electrode CT to which a common signal with a reference potential for the potential of the video signal is supplied via a common line CL, as shown in FIG. 1, for example. Although the pixel electrode PX and the common electrode CT are schematically depicted in linear shapes in FIG. 1, configurations of the pixel electrode PX and the common electrode CT according to the first embodiment will be described later in detail. In addition, although the thin film transistor TFT according to the first embodiment is driven such that the drain electrode and the source electrode are switched by application of bias thereof, a side connected to the drain line DL will be referred to as a drain electrode while the other side connected to the pixel electrode PX will be referred to as a source electrode in this specification.

An electric field with a component parallel to a main surface of the first substrate SUB1 occurs between the pixel electrode PX and the common electrode CT, and the liquid crystal molecules are driven by the electric field. Such a liquid crystal display device is known as a device capable of performing so-called wide viewing angle display and is referred to as a lateral electric field scheme due to uniqueness in application of the electric field to the liquid crystal. In addition, the liquid crystal display device according to the first embodiment is designed to perform display in a normally black display mode in which the light transmittance is minimized (black display) when the electric field is not applied to the liquid crystal and the light transmittance is raised by applying the electric field.

End portions of each drain line DL and each gate line GL extend over the seal member SL and are connected to the drive circuit DR which generates drive signals such as a video signal and a scanning signal based on input signals input from an external system via a flexible print substrate FPC. However, although the liquid crystal display device according to the first embodiment is configured such that the drive circuit DR is formed by a semiconductor chip and mounted on the first substrate SUB1, another configuration is also applicable in which one of or both a video signal drive circuit outputting the video signal and a scanning signal drive circuit outputting the scanning signal may be mounted on the flexible print substrate FPC based on a tape carrier scheme or a COF (Chip On Film) scheme, and connected to the first substrate SUB1.

### [Detailed Configuration of Pixel]

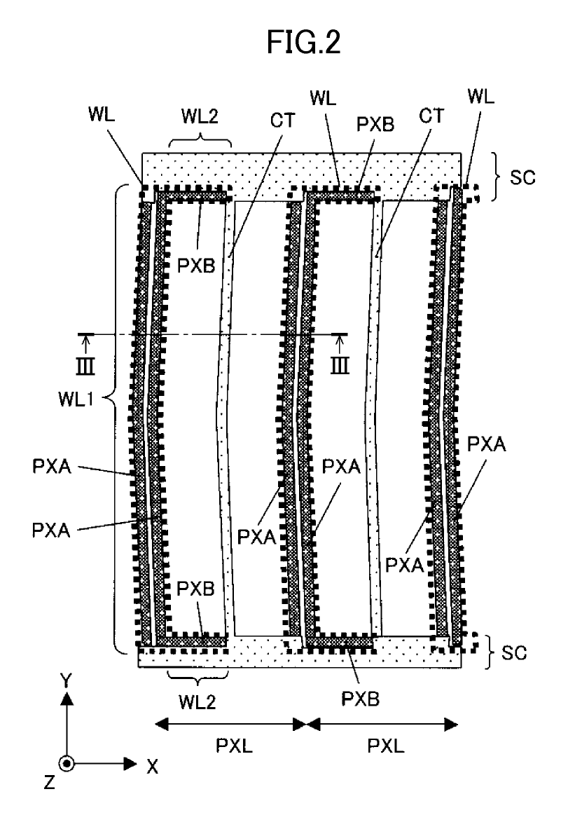

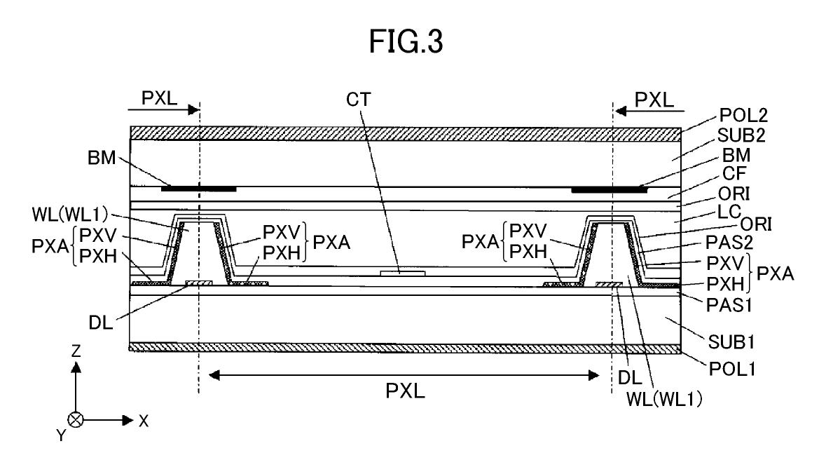

FIG. 2 is an enlarged view of the first substrate side for illustrating a pixel configuration in the liquid crystal display device according to the first embodiment of the present invention, and FIG. 3 is a cross-sectional view taken along a line in FIG. 2. Hereinafter, description will be given of the pixel configuration in the liquid crystal display device according to the first embodiment based on FIGS. 2 and 3. However, description of components such as the thin film transistor will be omitted for the purpose of simplification. In addition, the enlarged view of the pixels PXL in FIG. 2 shows two pixels which are adjacent in the X direction.

In the requid crystal display device according to the first embodiment, a conducting film in which the pixel electrodes PX and the retentive capacitors SC are formed is circularly formed along all of four side portions of each pixel PXL, namely a periphery of the pixel region, as shown in FIG. 2. With such a configuration, even if a part of the pixel electrode PX is disconnected, both sides of the disconnected part are connected to the source electrode of the thin film transistor as a supply source of the video signal, and therefore, there is also an effect in that the video signal can be stably supplied.

In addition, the periphery (peripheral edge portions) of each pixel has a convex shape shown by a dotted line in the drawing, and an insulating film (hereinafter, simply referred to as a convex) WL forming a level difference in the side portions of each pixel PXL is formed. In the configuration of the liquid crystal display device according to the first embodiment, the wall-shaped pixel electrodes PX (wall-shaped pixel electrodes PXA and PXB) as first electrodes are formed such that a part of the convex WL and a part of the transparent conducting film overlap with each other.

Particularly, the wall-shaped pixel electrodes PXA as a pair of pixel electrodes PX extending in the longer-side direction (Y direction) of the pixel region PXL and arranged so as to face each other in the shorter-side direction via the pixel display portion are formed so as to be in the proximity to the wall-shaped pixel electrodes PXB as adjacent pixels which are adjacent in the X direction, among the pairs of pixel electrodes arranged so as to face each other in a plane with the pixel display portion interposed therebetween. On the other hand, the wall-shaped pixel electrodes PXB as a pair of pixel electrodes PX extending in the shorter-side direction (X direction) of the pixel region PXL and arranged so as to face each other in the longer-side direction via the pixel display portion are integrated with the wall-shaped pixel electrodes PXA on the left sides in the drawing so as to extend in the shorter-side direction (X direction) from the end portions of the wall-shaped pixel electrodes PXA formed on the left sides of the pixels in the drawing (the sides of the drain lines DL connected to the thin film transistors of the pixels, for example). On this occasion, the end portions on the right sides in the drawing, namely the sides on which the wall-shaped pixel electrodes PXB according to the first embodiment are not sequentially formed from the wall-shaped pixel electrodes PXA extend up to a position where the common electrodes CT are formed.

In order to form such wall-shaped pixel electrodes PXA and PXB, C-shaped convexes WL are formed so as to cross over the pixel regions which are adjacent to each other in the X direction, in the liquid crystal display device according to the first embodiment.

In each of the C-shaped convexes WL, a convex (first convex) WL1 formed along the longer-side direction of the pixel region PXL and a convex (second convex) WL2 formed along the shorter-side direction of the pixel PXL are integrated. Since circular transparent conducting films which serve as the wall-shaped pixel electrodes PXA and PXB are formed along the convexes WL, the liquid crystal can move between the pixels, which are vertically adjacent to each other in the drawing, even during adhering process between the first substrate SUB1 and the second substrate SUB2 and in use after the adhering process. Although the wall-shaped pixel electrodes PXA and PXB for the pixel are formed using the circular transparent conducting films in the first embodiment, the configuration is not limited thereto, and another configuration is also applicable in which notch portions or the like are formed at parts of the transparent conducting films to form the wall-shaped pixel electrodes PXA and PXB with C-shaped conducting films, for example, instead of circular conducting films.

The pixel PXL according to the first embodiment has a configuration in which a linear common electrode (second electrode) CT extending in substantially parallel to the wall-shaped pixel electrodes PXA is formed between the wall-shaped pixel electrodes PXA formed along a pair of side portions extending in the longer-side direction. That is, the common electrode CT is formed so as to divide the pixel display portion, which is a region between the pair of wall-shaped pixel electrodes PXA, into two regions in the shorter-side direction (X direction). The common electrode CT is also formed with the transparent conducting film. Here, it is possible to employ ITO (Indium Tin Oxide) as a material of a transparent conducting film and zinc oxide series such as AZO (Aluminum doped Zinc Oxide) and GZO (Gallium doped Zinc Oxide) for the transparent conducting film forming the wall-shaped pixel electrodes PXA and PXB and the common electrode CT.

Moreover, the pixel PXL according to the first embodiment has a configuration in which transparent conducting films for forming the common electrodes CT are formed on the sides of the upper end and the lower end of the pixel region in FIG. 2 and the transparent electrodes at the upper end and the lower end are integrally formed with the transparent conducting films at the upper end and the lower end of the adjacent pixels so as to also function as a common line CL. Furthermore, even if a part of the common electrode CT is disconnected, both ends of the disconnected part is connected to the supply source of the common signal, and therefore, there is also an effect in that the common signal can be stably supplied.

In addition, the transparent conducting films for forming the wall-shaped pixel electrodes PXA and PXB are also formed via the insulating films in the regions on the sides of the upper end and the lower end of the pixel region, and the retentive capacitors SC are formed in a space formed with the planar transparent conducting films forming the common electrodes CT. In addition, the detailed configuration of the retentive capacitor SC will be further described later.

Furthermore, the pixel PXL according to the first embodiment is configured such that an upper region and a lower region thereof in the longer-side direction (Y direction) in FIG. 2 are inclined in different directions so as to be symmetrical with respect to the Y direction and the upper region and the lower region are connected to each other at the center of the pixel. With such a configuration, the liquid crystal molecules are initially oriented in the Y direction both in the upper region and in the lower region, for example. That is, each pixel PXL is bent at the center thereof, an the liquid crystal molecules are oriented in the Y direction (in the longitudinal direction in FIG. 2). In so doing, the rotation directions of the liquid crystal molecules during voltage application become opposite in the upper and lower parts from the bent portion at which the upper region and the lower region are in contact with each other, and the liquid crystal molecules are rotated in the counterclockwise direction in the upper region from the bent portion while rotated in the clockwise direction in the lower region from the bent portion. As described above, a so-called multi-domain configuration is employed to offset coloring in the view angle direction by forming the regions with opposite rotation directions within one pixel. In addition, although the pixel according to the first embodiment has a configuration in which the upper region is inclined in the counterclockwise direction while the lower region is inclined in the clockwise direction with respect to the Y direction, another configuration is also applicable in which the upper region and the lower region are inclined to the opposite directions.

In the liquid crystal display device according to the first embodiment with such a configuration including the wall-shaped pixel electrodes PXA and PXB and the common electrodes CT, the gate lines which are not shown in the drawings are formed so as to extend in the X direction and be arranged next to one another in the Y direction on the upper surface of the first substrate SUB1 (on the side of the liquid crystal surface), and an insulating film PAS1 is formed over the entire surface of the first substrate SUB1 so as to cover the gate lines, as shown in FIG. 3. A known semiconductor layer which is not shown in the drawings is formed in a region, which overlaps with the gate lines, on the upper surface of the insulating film PAS1, and the insulating film PAS1 functions as a gate insulating film in the region where the gate lines and the semiconductor layer overlap with each other. In addition, a drain line DL made of a metal thin film, for example, and an extending portion extending from the drain line are formed in the upper layer of the insulating film PAS1 or the semiconductor layer, and the extending portion is electrically connected to one end of the semiconductor layer to form a drain electrode. In this process, a source electrode made of a metal thin film is formed at the other end of the semiconductor layer, and the source electrode and the wall-shaped pixel electrodes PXA and PXB are electrically connected to each other in the later process.

The convex WL1 made of an insulating film for forming a level difference along the side edge portions of the pixel region is formed so as to overlap with the drain line DL, in the upper layer of the drain line DL. On this occasion, the convex WL1 according to the first embodiment is formed so as to cross over the adjacent pixel regions in the X direction.

A wall-shaped electrode PXV made of a transparent conducting film is formed on the side wall surface (the side wall surface of the level difference) of the convex WL. In addition, a planar electrode PXH along the main surface of the first substrate SUB1 is formed in a sequential manner from the side of the lower end of the wall-shaped electrode PXV in FIG. 3, namely an end portion of the wall-shaped electrode PXV on the side of the first substrate SUB1, and the wall-shaped electrode PXV and the planer electrode PXH form the wall-shaped pixel electrodes PXA and PXB. With such a configuration, the wall-shaped pixel electrode PXA is formed so as to stand from the main surface of the first substrate SUB1 toward the side on which the second substrate SUB2 is arranged.

In addition, the wall-shaped pixel electrode PXB formed at each of the side portions on the shorter sides of the pixel is also formed by the wall-shaped electrode PXV formed on each side wall surface of the convex WL2 and the planar electrode PXH along the main surface of the first substrate SUB1. On this occasion, the electrode (capacitive electrode) forming the retentive capacitor SC arranged at each of the upper end portion and the lower end portion of the pixel region is configured to extend from the side of the upper end of the wall-shaped electrode PXV as will be described later. Accordingly, the conductive thin film extending from the wall-shaped electrode PXV is formed in the top vertex surface of the convex WL2 with the wall-shaped pixel electrode PXB formed therein, so as to cover the top vertex surface.

An insulating film PAS2 is formed on the entire surface of the first substrate SUB1 as an upper layer of the wall-shaped pixel electrodes PXA and PXB so as to cover the wall-shaped pixel electrodes PXA and PXB, and the linear common electrode CT is formed as the further upper layer. An oriented film ORI is formed on the entire surface of the first substrate SUB1 on the further upper layer of the common electrode CT so as to cover the common electrode CT to control the initial orientation direction of the liquid crystal molecules.

According to this configuration, a backlight unit which is not shown in the drawings is arranged on the rear surface side of the liquid crystal display panel PNL according to the first embodiment, namely the surface of the first substrate SUB1 on the side facing the liquid crystal surface. The backlight beam, which is not shown in the drawings, emitted from the backlight unit is incident on the liquid crystal display panel PNL via the polarizing plate POL1 from the side of the polarizing plate POL1 attached to the first substrate SUB1 on the side of the backlight unit. The incident light is modulated by the liquid crystal display panel PNL and then output as display light via the polarizing plate POL2 attached to the side of the display surface of the liquid crystal display panel PNL, namely the second substrate SUB2 on the side of the liquid crystal surface.

In the liquid crystal display device according to the first embodiment, the drain line DL to which the video signal is supplied, the drain electrode and the source electrode of the thin film transistor, and the pixel electrodes PXA and PXB are formed on the upper surface of the insulating film PAST, namely the same layer as described above. With such a configuration, components such as the drain line DL are formed to be electrically connected to the semiconductor layer of the thin film transistor without the insulating film interposed therebetween. Accordingly, it is not necessary to form known through-holes even for the electrical connection between the drain line DL or the wall-shaped pixel electrodes PXA and PXB and the semiconductor layer of the thin film transistor, and therefore, it is possible to reduce the number of processes and enhance the aperture ratio because regions for forming the through hole are not required.

In addition, it is possible to reduce the number of layers of insulating films with the through-holes formed therein and to enhance the aperture ratio by forming the wall-shaped pixel electrodes PXA and PXB in a layer which is closer to the thin-film layer where signal wirings such as the thin film transistor and the drain line are formed than to the common electrode CT even when a thin film layer with the signal wirings such as the drain line DL formed therein and a thin film layer with the wall-shaped pixel electrodes PXA and PXB formed therein are separately formed, that is, the two films are formed via an insulating film.

In addition, the liquid crystal display panel PNL according to the first embodiment has a configuration in which the thin film transistor TFT is formed in the vicinity of an intersection between the drain line DL and the gate line, in a region on the upper side or the lower side of the pixel, and at a position extended from the wall-shaped pixel electrode PXA. In so doing, it is possible to form the thin film transistor TFT in a region where the light is blocked due to the black matrix (light blocking film) BM and to enhance the aperture ratio of the pixel. However, the formation position of the thin film transistor TFT is not limited thereto, and another position may be also selected.

On the other hand, the black matrix BM as a light blocking film is formed on the facing surface side, which is the side of the liquid crystal layer LC, among the surfaces of the second substrate SUB2 arranged so as to face the first substrate SUB1 via the liquid crystal layer LC. The black matrix BM is formed in a region between adjacent pixels and formed along the periphery of each pixel PXL in the X and Y directions, in the same manner as in the related art. However, the black matrix BM may be formed only in the Y direction in which the drain line DL extends.

In addition, one of color filters CF for red (R), green (G), and blue (B) colors is formed for each pixel PXL in the second substrate SUB2 on the side of the liquid crystal surface, and three pixels PXL corresponding to RGB form a unit pixel for color display. In addition, a known oriented film ORI is formed in the upper layer of the color filters CF, namely on the side of the liquid crystal surface, so as to cover the black matrix BM and the color filters CF.

### [Detailed Configuration of Retentive Capacitor Region]

FIG. 4 is an enlarged view illustrating a detailed configuration of an end portion of a pixel in the liquid crystal display device according to the first embodiment of the present invention, and FIG. 5 is a diagram illustrating a detailed configuration of an end portion of a pixel in a liquid crystal display device provided only with wall-shaped pixel electrodes, which also shows operations of a liquid crystal molecules LCM when an electric field for image display is applied between the wall-shaped pixel electrodes PXA and PXB and the common electrode CT. Moreover, FIG. 6 is a cross-sectional view taken along a line VI-VI in FIG. 4, and FIG. 7 is a cross-sectional view taken along a line VII-VII in FIG. 4. Furthermore, FIG. 8 is a cross-sectional view of a liquid crystal display device according to another embodiment corresponding to FIG. 6, which illustrates a formation position of one capacitive electrode forming the retentive capacitor SC.

However, the upper region where the wall-shaped pixel electrodes PXA and PXB and the common electrode CT are inclined in the clockwise direction with respect to the liquid crystal orientation direction (initial orientation direction) and the lower region where the wall-shaped pixel electrodes PXA and PXB and the common electrode CT are inclined in the counterclockwise direction have the same configurations other than the presence of the thin film transistor which is not shown in the drawings. Accordingly, detailed description will be given hereinafter of a planar electrode configuration for forming the retentive capacitor SC in the first substrate SUB1 in the upper region where the wall-shaped pixel electrodes PXA and PXB and the common electrode CT are inclined in the clockwise direction. In addition, the following description will be given of a case in which a video signal with a higher voltage is supplied to the wall-shaped pixel electrodes PXA and PXB than that for the common electrode CT, for the purpose of simplification of the description and alternating voltage with a polarity inverted at a predetermined cycle of one frame or the like and with a direction of an electric field, which is applied to the liquid crystal molecules, alternatively inverted is applied between the wall-shaped pixel electrodes PXA and PXB and the common electrode CT.

In addition, description will be given on the assumption that a first region AP1 represents a region on the left side in the drawing, namely a region on the side of a major angle of the common electrode CT bent in the V shape while a second region AP2 represents a region on the right side in the drawing, namely a region on the side of a minor angle of the common electrode CT bent in the V shape, in the pixel display region interposed between the wall-shaped pixel electrodes PXA and the common electrodes CT. Furthermore, a capacitive electrode (first capacitive electrode) PXS represents an electrode formed with a transparent conducting film extending from the wall-shaped pixel electrode PXB while the capacitive electrode (first capacitive electrode) CTS represents an electrode formed with a transparent conducting film extending from the common electrode CT, among the electrodes in the formation region of the retentive capacitor SC.

As shown in FIG. 4, the side edge portion of the capacitive electrode CTS on the side of the pixel display portion has different shapes in the formation region of the retentive capacitor SC on the side of the first region AP1 which is a region on the side where the wall-shaped pixel electrode PXB is formed and in the formation region of the retentive capacitor SC on the side of the second region AP2 which is a region on the side where the wall-shaped pixel electrode PXB is not formed. In addition, the capacitive electrode PXS and the capacitive electrode CTS on the side of the second region AP2 are formed such that the end surfaces thereof on the side of the pixel display portion are arranged in a line. On the other hand, the side edge portion of the capacitive electrode CTS is formed so as to be retreated from the side edge portion of the capacitive electrode PXS and the capacitive electrode CTS in the lower layer is exposed when viewed from the side of the display surface (the side of the liquid crystal surface) in the formation region of the retentive capacitor SC on the side of the first region AP1. That is, the side portion of the capacitive electrode CTS on the side of the pixel display portion has a configuration in which a concave region (retreating region RT) retreating in the X direction (an in-plane direction of the first substrate SUB1) is sequentially formed from the pixel display portion of the pixel. On the other hand, the side edge portion of the capacitive electrode PXS on the side of the first region AP1 and the side edge portion of the capacitive electrode PXS on the side of the second region AP2 are arranged in a line and formed in a linear shape in the X direction.

With such a configuration, a side edge portion of the capacitive electrode CTS with the same potential as that of the common electrode CT is formed in the second region AP2 when viewed from the liquid crystal layer LC, at the end portions of the wall-shaped pixel electrode PXA and the common electrode CT, namely at the side portion of the formation region for the retentive capacitor SC on the side of the pixel display portion among the side portions of the pixel display portion. Accordingly, as shown in FIG. 4, the direction in the side portion of the pixel display portion becomes a normal twist direction and the liquid crystal molecules LCM are also rotated in a plane in the normal twist direction shown as −θ.

In addition, a retreating region RT in which the capacitive electrode CTS is further retreated as compared with the capacitive electrode PXS in the lower layer is formed in the side portion of the pixel display portion on the side of the first region AP1, and the capacitive electrode PXS is exposed when viewed from the side of the liquid crystal surface. That is, the side edge portion of the capacitive electrode PXS is arranged in the side portion of the pixel display portion, and therefore, the direction of the electric field applied to the liquid crystal molecules LCM in the vicinity of the side edge portion also becomes the normal twist direction and the liquid crystal molecules LCM are also rotated in the normal twist direction.

On the other hand, a line of electric force directed from the capacitive electrode PXS toward the side edge portion of the capacitive electrode CTS occurs in the side edge portion of the retreating region RT, namely the side edge portion of the capacitive electrode CTS, as will be described later. On this occasion, the direction of the electric field applied to the liquid crystal molecules LCM in the electric field becomes the reverse twist direction as shown in FIG. 5 at one of corners of the retreating region RT, which is close to the side of the common electrode CT and to a border between pixels, namely a corner of the bottom end portion of the concave region in the X direction, which is formed in the capacitive electrode CTS, on the side of the common electrode, and the liquid crystal molecules LCM are also rotated in the reverse twist direction shown as θ in this region (the region shown as a twist reverse region RA in FIG. 5).

On the other hand, the convex WL2 according to the first embodiment is configured to be formed on the side of the first region AP1, and particularly configured such that the side edge portion of the capacitive electrode CTS on the side of the pixel display portion is formed along a top vertex portion of the convex WL2, in the first embodiment. That is, the convex WL2 is formed in a region in which the direction of the electric field applied to the liquid crystal molecules LCM in the electric field direction is the reverse twist direction, and a region from which the liquid crystal is cleared off (a region shown as a liquid crystal clearance region EA in FIG. 4) is formed in a gap with the second substrate SUB2. With such a configuration, the capacitive electrode CTS as an electrode on the side where no wall-shaped pixel electrode PXB is formed among a pair of capacitive electrodes PXS and CTS forming the retentive capacitor SC does not extend over the convex WL2 up to the side of the pixel display portion in the pixel configuration according to the first embodiment as can be understood from FIG. 6. However, the convex WL2 is configured to extend up to a region including the corner of the retreating region RT, which is a region where the reverse twist occurs.

Furthermore, the liquid crystal display device according to the first embodiment has a configuration in which a transparent conducting film forming the wall-shaped pixel electrode PXB entirely covers the side wall surface on the side of the pixel display portion, the top vertex surface, and the surface on the further side from the pixel display portion (on the side of the upper end in which the retentive capacitor is formed) of the convex WL2 in which the wall-shaped pixel electrode PXB is formed as shown in FIG. 6. On this occasion, an insulating film PAS2 is formed so as to cover the wall-shaped pixel electrode PXB and the capacitive electrode PXS extending from the wall-shaped pixel electrode PXB to form the capacitive electrode in the pixel configuration according to the first embodiment. Furthermore, the capacitive electrode CTS is formed in the Y direction in a range from the top vertex surface via the side wall surface of the convex WL2 up to the formation region for the retentive capacitor SC, namely a range up to the end portion of the pixel in the Y direction, in the upper layer of the insulating film PAS2 (the surface on the side of the liquid crystal). The oriented film ORI is formed in the further upper layer of the capacitive electrode CTS.

In the region where the convex WL2 is formed, the convex WL1 extending in the Y direction and including the wall-shaped pixel electrode PXA formed therein along the extending direction of the drain line DL, to which the video signal for the pixel shown at the center in the drawing is supplied, and the convex WL2 extending in the X direction and including the wall-shaped pixel electrode PXB formed therein are integrally formed as shown in FIG. 7. On this occasion, the convex WL2 is formed only on the side of the first region AP1, and therefore, the wall-shaped pixel electrode PXB is also configured to be formed only on the side of the first region AP1. However, the transparent conducting film extending from the wall-shaped pixel electrode PXB is formed as the capacitive electrode PXS forming the retentive capacitor SC from the top vertex surface to the side wall surface of the convexes WL1 and WL2 extending in the X direction, so as to cover the region up to the side wall surface of the convex WL1 on the side of the second region AP2. In addition, the capacitive electrode CTS as the other electrode forming the retentive capacitor SC is formed so as to cover a region from the side wall surface of the convex WL2 where the wall-shaped pixel electrode PXB is formed up to the side wall surface of the convex WL1 on the side of the second region AP2.

By providing such a convex WL2, a significantly thin liquid crystal layer LC is formed, or the oriented film ORI formed in the second substrate SUB2 on the side of the liquid crystal surface and the oriented film ORI formed in the top vertex portion of the convex WL abut on each other, in a region between the convex WL2 and the second substrate SUB2 as shown in FIGS. 6 and 7, and the liquid crystal clearance region EA is thus constructed.

In addition, the first embodiment is configured such that the capacitive electrode CTS is not formed while crossing across the top vertex surface of the convex WL2 up to the side of the pixel display portion, on the side of the first region AP1. Accordingly, the wall-shaped electrode PXV and the planar electrode PXH of the wall-shaped pixel electrode PXB are formed on the side which is closer to the pixel display portion than to the convex WL2 in a part where the wall-shaped pixel electrode PXB is formed.

Furthermore, since the capacitive electrode CTS is formed along the top vertex surface of the convex WL2, an electric field in the reverse twist direction occurs in the liquid crystal clearance region EA at an end surface part of the convex WL2, namely a side edge portion of the convex WL2 on one side of the capacitive electrode CTS which is further from the pixel display portion. If reverse twist of the liquid crystal molecules LCM occurs in the liquid crystal clearance region E1, which also works on the orientation of the liquid crystal molecules LCM in the vicinity to cause the reverse twist, a domain is generated in a region where the normal twist and the reverse twist counteract on each other. However, since the liquid crystal clearance region EA is formed by the convex WL2 in the pixel configuration according to the first embodiment, it is possible to suppress the reverse twist of the liquid crystal molecules LCM due to the electric field in the reverse twist direction. Accordingly, it is possible to suppress (cancel) the occurrence of the domain resulting from the reverse twist of the liquid crystal molecules LCM and to enhance the display mode efficiency.

Instead of the liquid crystal display device according to the first embodiment with the above configuration, the convex WL is formed only at pixel region parts which are adjacent to each other in the X direction as shown in FIG. 5 when the technique described in JP2007-3877A is applied to the liquid crystal display device provided with the wall-shaped pixels PXA. That is, the convex WL1 is formed only in a region corresponding to the wall-shaped pixel electrode PXA according to the first embodiment. In such a configuration, the liquid crystal layer LC is formed to have the same liquid crystal layer thickness as that in the pixel display portion in the other region than the region where the convex WL1 is formed even when the side edge portion of the capacitive electrode CTS on the side of the pixel display portion is made to retreat to the further side from the pixel display portion than the side edge portion of the capacitive electrode PXS on the side of the first region AP1. Accordingly, the reverse twist region RA is formed along the side edge portion of the capacitive electrode CTS, the reverse twist of the liquid crystal molecules LCM occurring in the reverse twist region RA affects the orientation of the liquid crystal molecules LCM in the region where only the capacitive electrode PXS is formed, the orientation of the liquid crystal molecules LCM in the pixel display portion is also affected by the reverse twist, and the display mode efficiency is lowered, in the liquid crystal display device shown in FIG. 5.

Although the above description was given of the liquid crystal display device according to the first embodiment with the configuration in which the side edge portion of the capacitive electrode CTS is formed in the top vertex portion of the convex WL2, the present invention is not limited thereto. Another configuration is also applicable in which the side edge portion of the capacitive electrode CTS is formed on one of the side wall surfaces of the convex WL2, which is on the further side from the pixel display portion, and further, on the further side from the pixel display portion than the convex WL2 as shown in FIG. 8, for example. Even with such a configuration, the reverse twist of the liquid crystal molecules LCM occurs on the further side from the pixel display portion among the side edge portion of the convex WL2 and the side edge portion of the capacitive electrode CTS. However, a configuration in which the liquid crystal clearance region EA is formed by the convex WL2 makes it possible to prevent the liquid crystal molecules LCM in the pixel display portion from being affected by the reverse twist of the liquid crystal molecules LCM.

As described above, the liquid crystal display device according to the first embodiment has a configuration in which the drain line DL as a signal wiring and the wall-shaped pixel electrodes PXA and PXB are formed in the same layer, that is, the wall-shaped pixel electrodes PXA and PXB are formed in the closer layer to the layer (thin film layer) in which signal wirings such as the drain line DL and the gate line, which is not shown in the drawing, than the common electrode CT. For this reason, the retreating region RT is formed by causing the side portion of the capacitive electrode CTS, which is formed in the thin film layer at a further position from the signal wirings, namely the thin film layer on the closer side to the liquid crystal layer LC, on the side of the pixel display portion to be further retreated as compared with the side portion of the capacitive electrode PXS, from among the capacitive electrodes PXS and CTS forming the retentive capacitor SC at the end portion of the pixel for which the retentive capacitor SC is formed. On this occasion, the retreating region RT is formed only on the side of the first region AP1, which is the pixel display portion on the side where the liquid crystal molecules LCM are in the normal twist direction, among the two divided pixel display portions by the common electrode CT. Furthermore, the liquid crystal clearance region EA is formed in a configuration in which the side portion of the retreating region RT is formed in the top vertex surface of the convex WL2 where the wall-shaped pixel electrode PXB is formed, and therefore, it is possible to clear up the reverse twist of the liquid crystal molecules LCM due to the electric field in the reverse twist direction occurring between the end portion of the capacitive electrode CTS and the capacitive electrode PXS. As a result, it is possible to prevent the transmittance from being lowered due to the domain generated by the reverse twist of the liquid crystal molecules LCM at the end portions of the wall-shaped pixel electrodes PXA and PXB and the common electrode CT, namely the end portion of the pixel display portion and to thereby enhance the display mode efficiency.

Furthermore, the wall-shaped pixel electrodes PXA and PXB are respectively configured by a side wall electrode PXV formed on the side wall surface of the convex WL and a planar electrode PXH extending from the end portion of the side wall electrode PXV in the in-plane direction of the substrate. Accordingly, it is possible to reduce the number of the lines of electric force directed toward the rear surface side of the first substrate from among the lines of electric force directed from the side wall electrode PXV toward the common electrode CT and to thereby further enhance the display mode efficiency.

Although the above description was given of the liquid crystal display device according to the first embodiment in the case where the cross-sectional shape of the convex WL taken along a plane which is perpendicular to the extending direction of the convex WL has a trapezoidal shape with a longer bottom side than the top vertex side, the present invention is not limited thereto. For example, a trapezoidal shape with a longer top vertex side than the bottom side, a rectangular shape, and a shape with curved side wall surfaces and/or a curved top vertex surface may be selected.

### Second Embodiment

FIG. 9 is an enlarged view of a first substrate side for illustrating a pixel configuration of a liquid crystal display device according to a second embodiment of the present invention, FIG. 10 is an enlarged view of a second substrate side for illustrating the pixel configuration in the liquid crystal display device according to the second embodiment of the present invention, and FIG. 11 is a cross-sectional view taken along a line XI-XI in FIG. 9. However, FIG. 9 is a diagram corresponding to FIG. 2 showing the first embodiment, and FIG. 11 is a diagram corresponding to FIG. 3 showing the first embodiment. In addition, the liquid crystal display device according to the second embodiment has the same configuration as that of the liquid crystal display device according to the first embodiment other than configurations of the first common electrode CT1 and the second common electrode CT2 linearly extending in the Y direction. Accordingly, the following description will be given of the configurations of the first and second common electrodes CT1 and CT2 in detail.

As shown in FIG. 9, the C-shaped convex WL which is formed so as to cross over the border between adjacent pixels in the X direction and formed between the pixel display portion and the region for the retentive capacitor SC formed at the end portion thereof in the Y direction is arranged, and the convex WL2 forms the liquid crystal clearance region EA which is not shown in the drawings, in the same manner in the pixel configuration according to the second embodiment. Furthermore, the wall-shaped electrode PXV is formed on the side wall surface of the convex WL while the planar electrode PXH is formed at the wall-shaped electrode PXV on the side of the first substrate SUB1 to form the wall-shaped pixel electrodes PXA and PXB. On this occasion, a region which is surrounded by the wall-shaped pixel electrodes PXA and PXB formed along the side wall surface on the inner side of the convex WL with the C shape in a plane and by the wall-shaped pixel electrode PXA formed along the outer wall of the convex WL formed at the C shape on the side of the pixel display portion corresponds to the pixel display portion, even in the second embodiment. In addition, a linear first common electrode CT1 extending in the Y direction is formed in the pixel display portion of each pixel, and the wall-shaped pixel electrode PXB is configured to extend from the side end portion on the left side of the pixel in the drawing to the formation position of the first common electrode CT1 in the same manner as in the first embodiment. Furthermore, the second embodiment also has a configuration in which the transparent conducting film forming the wall-shaped pixel electrodes PXA and PXB and the transparent conducting film forming the first common electrode CT1 form the retentive capacitor SC at the end portion of the pixel region in the longer-side direction. Accordingly, it is possible to achieve the same effect as that in the first embodiment.

In addition, the second substrate SUB2 is also provided on the side of the liquid crystal surface with the second common electrode (third electrode) CT2 formed as a linear common electrode as shown in FIG. 10 in the liquid crystal display device according to the second embodiment. The second common electrode CT2 is made of the same transparent conducting film as that of the first common electrode CT1, and a line width of the second common electrode CT2 is formed to be larger than that of the first common electrode CT1. Furthermore, the second common electrode CT2 is formed at a position facing via the liquid crystal layer LC the first common electrode CT1 formed on the first substrate SUB1 in a state where the first substrate SUB1 and the second substrate SUB2 are adhered to each other, as will be described later. That is, the first common electrode CT1 and the second common electrode CT2 are formed at overlapped positions in a planar view.

In addition, the second common electrode CT2 also has the configuration in which an electrode (planar electrode CT2S; fourth electrode) made of a transparent conducting film forming the second common electrode CT2 is formed at the end portion of the pixel in the longer-side direction in the same manner as the first common electrode CT1. The planar electrode CT2S is integrally formed with planar electrodes CT2S for the pixels which are adjacent in the X and Y directions and electrically connected thereto. With such a configuration, the planar electrode CT2S is used as a common line for supplying the common signal to the second common electrode CT2, and the common signal is supplied to the second common electrode CT2 at both ends of a disconnected part even when a part of the second common electrode CT2 is disconnected.

Furthermore, a retreating region RT2 is formed for the planar electrode CT2S on the side of the first region AP1 at a position corresponding to (facing) the retreating region RT formed in the capacitive electrode CTS as shown in FIG. 10. By forming the retreating region RT2, the reverse twist of the liquid crystal molecules LCM can be suppressed in the vicinity of the second substrate SUB2, which is caused by the electric field generated between the wall-shaped pixel electrodes PXA and PXB or the capacitive electrode PXS and the planar electrode CT2S.

Accordingly, it is possible to suppress (cancel) the domain occurring at the side edge portion of the pixel display portion, namely the side portion of the capacitive electrode PXS and to thereby enhance the display mode efficiency. However, another configuration is also applicable in which the retreating region RT2 is not formed for the planar electrode CT2S.

In addition, since the planar electrode CT2S is formed in the second substrate SUB2, the planar electrode CT2S and the capacitive electrode PXS face each other with the liquid crystal layer LC interposed therebetween. Accordingly, the planer electrode CT2S is considered to less contribute as the retentive capacitor SC, and therefore, a distance Y1 between the side edge portion of the planar electrode CT2S on the side of the pixel display portion in the second region AP2 and the side edge portion of the planar electrode CT2S in the first region AP1 as shown in FIG. 10, namely a length Y1 of the retreating region RT2 in the Y direction may be formed so as to be further separate in the direction of the adjacent pixel than a length of the retreating region RT2, which is formed for the capacitive electrode CTS, in the Y direction. Particularly, since it is possible to increase the distance between the side portion of the retreating region RT2 (the side edge portion of the planar electrode CT2S) and the side portion of the pixel display portion by setting the distance Y1 of the planar electrode CT2S (the length of the retreating region RT2 in the Y direction) to be equal to or longer than the length of the retreating region RT2 for the capacitive electrode CTS in the Y direction, a special effect can be achieved in that it is possible to further enhance the display mode efficiency while suppressing the occurrence of the reverse twist of the liquid crystal molecules LCM.

In the liquid crystal display device according to the second embodiment with the above configuration, the insulating film PAS1, the drain line DL, the convex WL, the wall-shaped pixel electrodes PXA and PXB, the insulating film PAS2, the first common electrode CT1, and the oriented film ORI are formed in this order in the first substrate SUB1 on the side of the liquid crystal as shown in FIG. 11. In addition, the black matrix BM is formed in the second substrate SUB2 on the side of the liquid crystal surface, and a color filter CF for any one of RGB is formed corresponding to the region divided by the black matrix BM. The second common electrode CT2 is formed at a position at which the second common electrode CT2 faces the first common electrode CT1 via the liquid crystal layer LC in the color filter CF on the side of the liquid crystal surface, and the oriented film ORI is formed at least within the display region of the second substrate SUB2 so as to cover the second common electrode CT2.

On this occasion, the liquid crystal display device according to the second embodiment is configured such that the first common electrode CT1 and the second common electrode CT2 are electrically connected to each other at the end portion of the liquid crystal display panel PNL, for example, and the same common signals are supplied thereto. In such a case, since the distance between the first common electrode CT1 and the second common electrode CT2 in the Z direction is sufficiently shorter than the distances between the wall-shaped pixel electrodes PXA and PXB and the first common electrode CT1 and second common electrode CT2 in the X direction, a region with the same potential (same potential region) is formed in the liquid crystal layer LC in the region in which the first common electrode CT1 and the second common electrode CT2 overlaps with each other in a planar view. Since the same potential region is also formed in a direction in which the wall-shaped pixel electrodes PXA and PXB protrude (Z direction) and functions as a pseudo wall-shaped electrode (pseudo wall-shaped common electrode), a line of electric force generated between the wall-shaped pixel electrodes PXA and PXB and the pseudo wall-shaped common electrode is formed in parallel to the in-plane direction of the first substrate SUB1 as compared with the liquid crystal display device according to the first embodiment. As a result, it is possible to rotate the rotation direction of the liquid crystal molecules in further parallel to the in-plane direction of the first substrate SUB1 and to thereby obtain a special effect in that the transmittance of the liquid crystal display device can be enhanced and the display mode efficiency can be further enhanced, in addition to the effect obtained in the first embodiment.

Furthermore, the width of the same potential surface of the pseudo wall-shaped common electrode, which is formed in the region between the first common electrode CT1 and the second common electrode CT2, in the X direction is formed to be thinner than that of the first common electrode CT1. As a result, it is possible to generate the in-plane direction (lateral electric field) even in the region where the first common electrode CT1 or the second common electrode CT2 is formed and to drive the liquid crystal molecules in this region, and therefore, a special effect can be achieved in that the aperture ratio of each pixel can be enhanced.

Although the above description was given of the liquid crystal display device according to the second embodiment in the case in which the convex WL1 where the wall-shaped pixel electrode PXA is formed and the convex WL2 where the wall-shaped pixel electrode PXB is formed are integrally formed, the present invention is not limited thereto. For example, another configuration is also applicable which is formed in a different process such as a process in which the convex WL1 formed so as to crossover the border between pixels (where the wall-shaped pixel electrode PXA is formed) is firstly formed and the convex WL2 where the wall-shaped pixel electrode PXB is formed with another thick film material is then formed. However, it is possible to reduce the number of processes for forming the convex WL by integrally forming the convex WL1 where the wall-shaped pixel electrode PXA is formed and the convex WL2 where the wall-shaped pixel electrode PXB is formed.

### Third Embodiment

FIG. 12 is an enlarged view of a first substrate side for illustrating a pixel configuration in a liquid crystal display device according to a third embodiment of the present invention, and FIG. 13 is a cross-sectional view taken along a line XIII-XIII in FIG. 12. Hereinafter, description will be given of the pixel configuration, in the liquid crystal display device according to the third embodiment based on FIG. 12 and FIG. 13. However, description of components such as the thin film transistor will be omitted for the purpose of simplification. In addition, the enlarged view of the pixels PXL in FIG. 12 shows two pixels which are adjacent in the X direction. Furthermore, in the pixel configuration according to the third embodiment, the region where the wall-shaped pixel electrode PXA and the common electrode CT extending in the longer-side direction of the pixel are inclined in the clockwise direction with respect to the Y direction and a region where the wall-shaped pixel electrode PXA and the common electrode CT are inclined in the counterclockwise direction are connected at the center in the longer-side direction, and the capacitive electrodes PXS and CTS forming the retentive capacitor SC are respectively formed at the end portions (the upper end portion and the lower end portion in the drawing) of the pixel in the longer-side direction, in the same manner as in the first embodiment.

As can be understood from the cross-sectional view in FIG. 13, the gate line which is not shown in the drawing is formed in the first substrate SUB1 on the side of the liquid crystal surface, and the insulating film PAS1 is formed on the entire surface of the first substrate SUB1 so as to cover the gate line, in the liquid crystal display device according to the third embodiment. The drain line DL and the common electrode CT are formed on the upper surface of the insulating film PAS1 (the surface on the side of the liquid crystal), and the insulating film PAS2 is formed on the entire surface of the first, substrate SUB1 so as to cover the drain line DL and the common electrode CT. A convex WL which is configured by the convex WL1 extending in the Y direction so as to cross over the border between adjacent pixels and convex WL2 extending in the X direction along the side edge portion of the pixel display portion from the end portion of the convex WL1 is formed on the upper surface of the insulating film PAS2. The wall-shaped pixel electrode PXA is formed by the wall-shaped electrode PXV formed on the side wall surface of the convex WL1 and the planar electrode PXH formed so as to extend in the in-plane direction in the first substrate SUB1 from the side portion of the wall-shaped electrode PXV on the side of the lower end by a predetermined amount. In addition, the oriented film ORI is formed on the entire surface of the first substrate SUB1 including the surface of the wall-shaped pixel electrode PXA. However, the liquid crystal display device according to the third embodiment is configured to include only the wall-shaped pixel electrode PXA along the extending direction of the drain line DL.

On the other hand, the configuration on the side of the second substrate SUB2 is the same as that in the liquid crystal display device according to the first embodiment, and the black matrix BM, the color filter CF, and the oriented film ORI are respectively laminated on the second substrate SUB2 on the side of the liquid crystal surface.

In the configuration of the third embodiment, the drain line DL extends in the Y direction, the common electrode CT is integrally formed with the capacitive electrode CTS which is a plate-shaped electrode forming the retentive capacitor SC at the end portion of the pixel in the longer-side direction, and the capacitive electrode CTS extends in the X direction. For this reason, the drain line DL and the capacitive electrode CTS intersect one another at a corner of the pixel. Accordingly, an insulating film which is not shown in the drawing is formed in the liquid crystal display device according to the third embodiment in order to prevent the drain line DL and the capacitive electrode CTS are short-circuited in the intersection region. However, the capacitive electrode CTS formed so as to extend from the common electrode CT is formed for each pixel, and the common lines CL which extend in the X direction and are arranged in the Y direction in the same layer as that of the gate line which is not shown in the drawing, to which the common signal is supplied, are formed and each common line CL and each capacitive electrode CTS may be electrically connected to each other within the region of each pixel.

The liquid crystal display device according to the third embodiment with the aforementioned configuration has the convex WL with a C-shaped (or M-shaped) outline including the convex WL1 formed so as to cross over the border between adjacent pixels and the convex WL2 extending from the end portion of the convex WL1 to the left side in the drawing as shown in FIG. 12. On this occasion, the third embodiment is configured such that the wall-shaped pixel electrode PXA is formed only on one of the side wall surfaces of the convex WL, which is along the longer-side direction of the pixel.

Among the wall-shaped pixel electrode PXA and the common electrode CT according to the third embodiment, the transparent conducting film forming the common electrode CT is formed in a closer layer to the signal wirings such as the drain line DL than the transparent conducting film forming the wall-shaped pixel electrode PXA along the side edge portion of the pixel region. That is, in the configuration according to the third embodiment, the transparent conducting film forming the wall-shaped pixel electrode PXA is formed in a closer layer to the liquid crystal layer LC than the transparent conducting film forming the common electrode CT. For this reason, the liquid crystal display device according to the third embodiment has a configuration in which the retreating region RT is formed for the capacitive electrode PXS, and the formation position thereof is in the second region AP2 on the right side in the drawing, which is divided by the common electrode CT. That is, the end portion of the capacitive electrode PXS on the side of the pixel display portion is further retreated than the end portion of the capacitive electrode CTS on the side of the pixel display portion, and the capacitive electrode CTS formed in the lower layer is exposed from the retreating region (retreating region RT) when viewed from the side of the liquid crystal layer LC. In the pixel configuration according to the third embodiment, however, a source electrode of the thin film transistor which is not shown in the drawing is also formed in the same layer as that of the drain line DL. Accordingly, the transparent conducting films forming the wall-shaped pixel electrode PXA and the capacitive electrode PXS and the source electrode are electrically connected to each other via a through-hole TH formed in the insulating film PAS2 arranged in the lower layer of the capacitive electrode PXS.

Furthermore, the liquid crystal display device according to the third embodiment has a configuration in which the end portion of the retreating capacitive electrode PXS, namely the side edge portion of the retreating region RT on the further side from the pixel display portion is formed in the top vertex surface of the convex WL2. With such a configuration, the gap between the top vertex portion of the convex WL2 and the second substrate SUB2 is significantly narrow, and the liquid crystal clearance region EA is formed, in the same manner as in the aforementioned liquid crystal display device according to the first embodiment, and therefore, it is possible to prevent the occurrence of the reverse twist of the liquid crystal molecules LCM even at the side portion of the capacitive electrode PXS and the corner of the retreating region RT. As a result, it is possible to clear up the occurrence of the domain resulting from the fact that the liquid crystal molecules LCM rotated in the reverse twist direction and the liquid crystal molecules LCM rotated in the normal twist direction counteract on each other at the side portion of the pixel display portion and to thereby enhance the display mode efficiency in the same manner as in the first embodiment.

### [Detailed Configuration of Retentive Capacitor Region]

Next, FIG. 14 is an enlarged view illustrating a detailed configuration of an end portion of a pixel in the first substrate according to the third embodiment of the present invention. FIG. 15 is an enlarged view illustrating a detailed configuration of an end portion of a pixel in a first substrate of a liquid crystal display device provided only with wall-shaped pixel electrodes. FIG. 16 is a cross-sectional view taken along a line XVI-XVI in FIG. 14. FIG. 17 is a diagram illustrating a formation region of the convex according to the third embodiment in FIG. 14. Hereinafter, description will be given of a suppression effect of the reverse twist of the liquid crystal molecules in the liquid crystal display device according to the third embodiment based on FIGS. 14 to 17. However, the directions of the electric fields to be applied to the liquid crystal molecules LCM are different from each other in the upper region and the lower region of each pixel in the same manner as in the first embodiment, and the basic pixel configurations are the same other than a configuration in which the rotation directions of the liquid crystal molecules are different. Therefore, detailed description is given hereinafter of the pixel configuration in the upper region of the pixel and the rotation operation of the liquid crystal molecules LCM.

Among the capacitive electrode PXS and the capacitive electrode CTS forming the retentive capacitor SC, when the transparent conducting film extending from the wall-shaped pixel electrode PXA is formed on the closer side to the liquid crystal layer LC than the capacitive electrode CTS as shown in FIG. 14, the domain resulting from the reverse twist of the liquid crystal molecules LCM occurs in the second region AP2. On this occasion, it is possible to move the reverse twist region RA to the corner of the retreating region RT by forming the retreating region RT for the capacitive electrode PXS on the side of the second region AP2 where the reverse twist occurs.

Accordingly, the liquid crystal display device according to the third embodiment employs a shape in which the end portion of the capacitive electrode PXS extending from the wall-shaped pixel electrode PXA is further retreated than the end portion of the capacitive electrode CTS extending from the common electrode CT. That is, among the pair of capacitive electrodes PXS and CTS forming the retentive capacitor SC at the upper end portion of the pixel region, the retreating region RT is formed for the capacitive electrode PXS formed in the further layer than the signal wirings such as the drain line DL. By forming the retreating region RT, the side edge portion of the capacitive electrode PXS on the side of the pixel display portion is formed to be further retreated than the side edge portion of the capacitive electrode CTS on the side of the pixel display portion.

In addition, the liquid crystal display device according to the third embodiment is provided with the convex WL2 formed in the X direction from the end portion of the convex WL1 formed in the Y direction in the side portion on the right side of the pixel region in the drawing. The convex WL2 is formed to have a length in the X direction, which is equal to or shorter than the length of the region where at least the common electrode CT is formed, to form the liquid crystal clearance region EA. Moreover, the length of the convex WL2 in the X direction is formed in the region including the reverse twist region RA which will be described later. In addition, the liquid crystal display device according to the third embodiment also has the configuration in which the end portion of the retreating region RT on the side of the pixel display portion, namely the side edge portion extending in the X direction is formed in the top vertex portion of the convex WL2 or on the closer side to the pixel border than the convex WL2.

In the liquid crystal display device according to the third embodiment with the above configuration, the side edge portion of the capacitive electrode PXS with the same potential as that of the wall-shaped pixel electrode PXA is formed in the upper layer in the first region AP1 at the end portions of the wall-shaped pixel electrode PXA and the common electrode CT, namely the side portion of the retentive capacitor SC formation region on the side of the pixel display portion, among the side portions of the pixel display portion. Accordingly, as shown in FIG. 14, the direction even in the side portion of the pixel display portion becomes a normal twist direction and the liquid crystal molecules LCM are rotated in a plane in the normal twist direction shown as −θ. In addition, the retreating region RT where the capacitive electrode PXS is further retreated than the capacitive electrode CT in the lower layer is formed at the side portion of the pixel display portion on the side of the second region AP2, and the capacitive electrode PXS is exposed on the side of the liquid crystal layer LC. That is, since the side edge portion of the capacitive electrode CTS is arranged at the side portion of the pixel display portion, the direction of the electric field applied to the liquid crystal molecules LCM in the vicinity of the side edge portion becomes the normal twist direction, and the liquid crystal molecules LCM are also rotated in the normal twist direction.

On the other hand, a line of electric force directed from the capacitive electrode PXS to the side edge portion of the capacitive electrode CTS occurs at the side edge portion of the retreating region RT, namely the side edge portion of the capacitive electrode PXS. On this occasion, the direction of the electric field applied to the liquid crystal molecules LCM in the electric field direction also becomes the reverse twist direction as shown in FIG. 15 at a corner which is close to the wall-shaped pixel electrode PXA and to the border between pixels among the corners of the retreating region RT, namely a corner on the side of the wall-shaped pixel electrode PXA among the end portions of the bottom side of the concave region, which is formed for the capacitive electrode PXS, in the X direction. In this region (the region shown as the reverse twist region RA in FIG. 15), the liquid crystal molecules LCM are also rotated in the reverse twist direction shown as θ.

On this occasion, the liquid crystal display device according to the third embodiment has a configuration in which the convex WL2 is arranged at the corner of the retreating region RT where the reverse twist of the liquid crystal molecules LCM occurs, to form the liquid crystal clearance region EA. In addition, the end portion of the capacitive electrode PXS is formed in the top vertex portion of the convex WL2 as shown in FIG. 16. Accordingly, it is possible to clear up the occurrence of the reverse twist of the liquid crystal molecules LCM by the liquid crystal clearance region EA in the same manner as in the aforementioned first embodiment and to achieve the same effect as in the first embodiment.

As compared with the aforementioned liquid crystal display device according to the third embodiment, the reverse twist of the liquid crystal molecules LCM occurs in the region RA at which the end side of the transparent conducting film, which forms the wall-shaped pixel electrode PXA and extends in the Y direction, on the side of the pixel display portion and the end portion extending in the X direction among the side portions of the retreating region RT intersect one another, in the liquid crystal display device provided with no convex WL2 as shown in FIG. 15. Since the reverse twist affects the normal twist of the liquid crystal molecules LCM in the pixel display portion, the domain is generated at the end portion of the pixel display portion, and the display mode efficiency is lowered.

When W0 represents the width of the pixel display portion of each pixel in the shorter-side direction, and W1 represents the width of the convex WL2 as shown in FIG. 17, W1=W0×10% or W1=W0×50% may be satisfied. That is, the width W1 of the convex WL2 preferably satisfies W0×10%≦W1≦W0×50%. By forming the convex WL2 defined by this range, it is possible to clear up the liquid crystal in the reverse twist direction which causes the occurrence of the domain and to suppress the domain. As a result, it is possible to suppress the domain in the entire pixels and to enhance the display mode efficiency. In addition, the width of the convex WL2 may be similarly applied to fourth and fifth embodiments which will be described later.

### Fourth Embodiment

FIG. 18 is an enlarged view illustrating a pixel configuration in a liquid crystal display device according to a fourth embodiment of the present invention. FIG. 19 is a diagram schematically illustrating a configuration of a second common electrode in the liquid crystal display device according to the fourth embodiment of the present invention. FIG. 20 is a cross-sectional view taken along a line XX-XX shown in FIG. 18. However, the liquid crystal display device according to the fourth embodiment has the same configuration as that of the liquid crystal display device according to the third embodiment other than the configuration of the common electrode CT configured by the second common electrode CT2 formed on the side of the second substrate SUB2. Accordingly, detailed description will be given hereinafter of the common electrode CT configured by the first common electrode CT1 and the second common electrode CT2.

As can be understood from FIG. 20, the liquid crystal display device according to the fourth embodiment is also configured to include a gate line which is not shown in the drawings, the insulating film PAS1 formed on the entire surface of the first substrate SUB1 so as to cover the gate line, the drain line DL and the first common electrode CT1 formed in the same layer on the upper surface (the surface on the side of the liquid crystal) of the insulating film PAS1, on the side of the first substrate SUB1. In addition, the liquid crystal display device includes the insulating film PAS2 formed on the entire surface of the first substrate SUB1 so as to cover the drain line DL and the first common electrode CT1 and the convex WL configured by the convex WL1 formed on the upper surface of the insulating film PAS2 so as to cross over the border between adjacent pixels and extend in the Y direction and the convex WL2 extending in the X direction along the side edge portion of the pixel display portion from the end portion of the convex, WL1. Furthermore, the liquid crystal display device includes a wall-shaped pixel electrode PXA configured by the wall-shaped electrode PXV formed on the side wall surface of the convex WL1 and the planar electrode PXH formed so as to extend in the in-plane direction in the substrate SUB1 by a predetermined amount from the side portion of the wall-shaped electrode PXV on the side of the lower end, and the oriented film ORI formed on the entire surface of the first substrate SUB1 including the surface of the wall-shaped pixel electrode PXA.

On the other hand, the second substrate SUB2 according to the fourth embodiment includes the black matrix BM, the color filter CF corresponding to each of RGB colors where the black matrix BM is formed, the second common electrode CT2 formed in the upper layer of the color filter CF, and the oriented film ORI formed on the entire surface of the second substrate SUB2 so as to cover the second common electrode CT2, on the side of the liquid crystal surface in the same manner as the second substrate SUB2 according to the second embodiment.

In the pixel configuration according to the fourth embodiment with the above configuration, the C-shaped convex WL which is opened on the left side in the drawing is arranged so as to cross over the border between adjacent pixels as shown in FIG. 18. On this occasion, the linear second common electrode CT2 with the wider wiring width than that of the first common electrode CT1 shown in FIG. 19 is formed at a position facing the first common electrode CT1 formed in the first substrate SUB1 via the liquid crystal layer LC. The same common signal as that for the first common electrode CT1 is supplied to the second common electrode CT2 in the same manner as in the second embodiment. As a result, the first common electrode CT1 and the second common electrode CT2 have the same potential via the liquid crystal layer LC in the region where the first common electrode CT1 and the second common electrode CT2 overlap with each other in a planar view, and a pseudo wall-shaped common electrode CT is formed.

On this occasion, in the pixel configuration according to the fourth embodiment, the first common electrode CT1 formed in the first substrate SUB1 is formed in a layer which is close to signal wirings such as drain line DL. Accordingly, the retreating region RT is formed at a part of the transparent conducting film forming the wall-shaped pixel electrode PXA corresponding to the second region AP2 at the pixel end portion of the retreating region RT where the retentive capacitor SC is formed. That is, the liquid crystal display device according to the fourth embodiment has a configuration in which the capacitive electrode PXS is formed in a closer side to the liquid crystal layer LC than the capacitive electrode CTS, and therefore, the retreating region RT is formed on the side of the second region AP2. Furthermore, since the pixel configuration according to the fourth embodiment is the same as that according to the third embodiment, and the end portion of the retreating region RT for the transparent conducting film forming the wall-shaped pixel electrode PXA is arranged in the top vertex portion of the convex WL2, namely the liquid crystal clearance region EA, it is possible to achieve the same effect as that in the third embodiment.

In addition, since the second common electrode CT2 according to the fourth embodiment is made to have the same shape as that of the second common electrode CT2 according to the second embodiment, it is possible to achieve the special effect in that the display mode efficiency can be further enhanced.

Furthermore, since a distance between the side portion of the retreating region RT2 (the side edge portion of the planar electrode CT2S) and the side portion of the pixel display portion can be longer in a configuration in which the distance Y1 of the planar electrode CT2S (the length of the retreating region RT2 in the Y direction) is equal to or longer than the length of the retreating region RT2 for the capacitive electrode CTS in the Y direction, a special effect can be achieved in which it is possible to further enhance the display mode efficiency while suppressing the occurrence of the reverse twist of the liquid crystal molecules LCM.

### Fifth Embodiment

FIG. 21 is an enlarged view showing two pixels for illustrating a pixel configuration in a liquid crystal display device according to a fifth embodiment of the present invention. FIG. 22 is a cross-sectional view taken along a line XXII-XXII in FIG. 21. However, the liquid crystal display device according to the fifth embodiment has the same configuration as that of the liquid crystal display device according to the third embodiment other than a configuration of a common electrode CTA with a wall shape (hereinafter, referred to as a wall-shaped common electrode) formed on the side wall surface of the convex WL1 and a configuration of a linear pixel electrode PX formed in a region between a pair of wall-shaped common electrodes CTA. Accordingly, detailed description will be given hereinafter of the configurations of the wall-shaped common electrode CTA and the pixel electrode PX.

As shown in FIG. 22, a gate line which is not shown in the drawing is formed in the first substrate SUM on the side of the liquid crystal surface, and the insulating film PAS1 is formed on the entire surface of the first substrate SUB1 so as to cover the gate line in the liquid crystal display device according to the fifth embodiment. The drain line DL extending in the Y direction and the pixel electrode PX made of a linear transparent conducting film extending in the Y direction are respectively formed on the upper surface of the insulating film PAS1, and the insulating film PAS2 is formed on the entire surface of the first substrate SUB1 so as to cover the drain line DL and the pixel electrode PX. The C-shaped (M-shaped) convex WL is formed on the upper surface of the insulating film PAS so as to cross over the border between pixels, and the wall-shaped common electrode CTA configured by a wall-shaped electrode CTV formed on the side wall surface of the convex WL so as to cover the convex WL1 of the convex WL and a planar electrode CTH formed so as to extend in the in-plane direction in the first substrate SUB1 from the side portion of the wall-shaped electrode CTV on the side of the lower end by a predetermined amount are formed. In addition, the oriented film ORI is formed on the entire surface of the first substrate SUB1 on the upper surface of the wall-shaped common electrode CTA so as to cover the wall-shaped common electrode CTA.

As can be understood from the above configuration, the liquid crystal display device according to the fifth embodiment has a configuration in which the side of the common electrode CT to which the common signal is supplied is formed with a wall-shaped electrode, namely the wall-shaped common electrode CTA. Furthermore, in relation to the common signal, the common signal, namely the same signal is supplied to each pixel, and therefore, the same signal is also supplied to the wall-shaped common electrode CTA even in the pixel configuration according to the fifth embodiment. Accordingly, the transparent conducting film forming the common electrode CT is formed both on the side wall surface of the convex WL1 for forming a level difference in the first substrate SUB1 on the side of the liquid crystal surface in order to form the wall-shaped electrode and on the top vertex surface thereof, and the wall-shaped common electrodes CTA of adjacent pixels are electrically connected.

In relation to the wall-shaped common electrode CTA according to the fifth embodiment, each wall-shaped common electrode CTA is formed by the wall-shaped electrode CT1 formed on the side wall surface of the convex WL and the planar electrode CT2 formed with a length W along the main surface of the first substrate SUB1 sequentially from the wall-shaped electrode CT1 in the same manner as the wall-shaped pixel electrode PXA according to the third embodiment. With such a configuration, the wall-shaped electrode CT1 standing (with inclination) on the main surface of the first substrate SUB1, that is, the wall-shaped electrode CT1 standing on the main surface of the first substrate SUB1 toward the side on which the second substrate SUB2 is arranged is formed, and the wall-shaped common electrode CTA is arranged so as to face the side edge portion of the pixel PXL in the longer-side direction along the peripheral portion of the pixel PXL. Since the wall-shaped common electrode CTA is formed at a border part between the adjacent pixels PXL in the fifth embodiment, the material of the wall-shaped common electrode CTA is not limited to the conductive film material with translucency and may be a conductive film material with no translucency such as a metal thin film including aluminum or chrome, for example.

In addition, the black matrix BM, the color filter CF, and the oriented film ORI are formed in this order in the second substrate SUB2 on the side of the liquid crystal surface in the same manner as in the third embodiment.

With such a configuration, the transparent conducting film forming the wall-shaped common electrode CTA is circularly formed in a region other than the pixel display portion of each pixel in the first substrate SUB1 on the side of the liquid crystal surface (the region including the capacitive electrode CTS functioning as the first capacitive electrode) as shown in FIG. 21 in the liquid crystal display device according to the first embodiment. On the other hand, the transparent conducting film forming the linear pixel electrode PX includes the capacitive electrode PXS functioning as the second capacitive electrode forming the retentive capacitor SC at each of the upper end portion and the lower end portion of each pixel region.

On this occasion, the capacitive electrode PXS is formed on the side of a layer which is close to the signal wirings such as the drain line DL and the gate line among the capacitive electrode PXS and the capacitive electrode CTS forming the retentive capacitor SC at each end portion of the pixel in the longer-side direction (Y direction) in the liquid crystal display device according to the fifth embodiment. Accordingly, in the pixel configuration according to the fifth embodiment, the retreating region RT is formed for the capacitive electrode CTS formed in the layer which is far from the signal wirings, namely, the layer which is close to the liquid crystal layer LC. On this occasion, since the common signal is supplied to the wall-shaped electrode, and the video signal is supplied to the linear electrode, the retreating region RT is formed for the capacitive electrode CTS on the side of the second region AP2. Furthermore, since the end portion of the retreating region RT, namely the end portion of the capacitive electrode CTS is formed in the top vertex surface of the convex WL2, and the corner of the retreating region RT is formed in the top vertex surface of each of the convex WL1 and the convex WL2, namely in the liquid crystal clearance region EA formed by the convex WL2, it is possible to achieve the same effect as that in the third embodiment.

### Sixth Embodiment

FIG. 23 is an enlarged view illustrating a pixel configuration in a liquid crystal display device according to a sixth embodiment of the present invention. FIG. 24 is a cross-sectional view taken along a line XXIV-XXIV in FIG. 23. However, the liquid crystal display device according to the sixth embodiment has the same configuration as that of the liquid crystal display device according to the first embodiment other than configurations of wall-shaped common electrodes (wall-shaped common electrodes CTA and CTB) formed on the side wall surfaces of the convex WL and a configuration of a linear pixel electrode PX formed in a region between the wall-shaped common electrodes CTA arranged so as to face each other with the pixel display portion interposed therebetween. Accordingly, detailed description will be given hereinafter of the configurations of the wall-shaped common electrodes CTA and CTB and the pixel electrode PX.

As shown in FIG. 24, the gate line extending in the X direction, which is not shown in the drawing, is formed in the first substrate SUB1 on the side of the liquid crystal surface, and the insulating film PAS1 is formed on the entire surface of the first substrate SUB1 so as to cover the gate line. The drain line DL extending in the Y direction is formed, and the convex WL is formed so as to cover the drain line DL in at least a region corresponding to the pixel display portion and cross over the border between adjacent pixels, on the upper layer of the insulating film PAS1. Here, the transparent conducting films forming the common electrodes CT are formed on the side wall surface and the top vertex surface of the convex WL configured by the convex WL1 and the convex WL2 to form the wall-shaped common electrodes CTA and CTB in the pixel configuration according to the sixth embodiment. The insulating film PAS2 is formed on the upper layer of the wall-shaped common electrodes CTA and CTB so as to cover the entire surface of the first substrate SUB1, and the linear pixel electrode PX is formed on the upper surface of the insulating film PAS2. The oriented film ORI is formed on the upper layer of the pixel electrode PX.

For the wall-shaped common electrodes PXA and PXB according to the sixth embodiment, the wall-shaped common electrodes CTA and CTB are formed by the wall-shaped electrode CTV formed in each of the side walls of the convexes WL1 and WL2 and the planar electrode CTH formed along the main surface of the first substrate SUB1 sequentially from the wall-shaped electrode CTV, in the same manner.

In addition, the black matrix BM, the color filter CF, and the oriented film ORI are formed in this order in the second substrate SUB2 on the side of the liquid crystal surface in the same manner as in the first embodiment.

The liquid crystal display device according to the sixth embodiment with the above configuration has a C-shaped convex WL configured by the convex WL1 formed along the side portion of the pixel in the longer-side direction (Y direction) and the convex WL2 formed along the pixel in the shorter-side direction from the end portion of the convex WL1 as shown in FIG. 23. On this occasion, the convex WL2 extends from the end portion of the convex WL1 up to the formation position of the pixel electrode PX which is a linear electrode in the same manner as in the first embodiment. With such a configuration, the side surface walls and the top vertex surface of the convex WL are respectively covered with the transparent conducting films forming the wall-shaped common electrodes CTA and CTB in the pixel configuration according to the sixth embodiment.

Furthermore, in the pixel configuration according to the sixth embodiment, the drain line DL and the wall-shaped common electrodes CTA and CTB are formed in the same layer, and the pixel electrode PX is formed via the insulating film PAS2 formed on the upper layer thereof, that is, the wall-shaped common electrodes CTA and CTB are formed in the layer which is closer to the signal wirings than the pixel electrode PX. Accordingly, the capacitive electrode CTS is formed on the closer side to the signal wirings, that is, the capacitive electrode PXS is formed on the closer side to the liquid crystal layer LC, among the capacitive electrode CTS and the capacitive electrode PXS forming the retentive capacitor SC. On this occasion, since the common signal is supplied to the wall-shaped electrode, and the video signal is supplied to the linear electrode, the retreating region RT is formed for the capacitive electrode PXS on the side of the first region AP1. Furthermore, since the end portion of the retreating region RT, namely the end portion of the capacitive electrode PXS is formed in the top vertex surface of the convex WL2, that is, the end portion is positioned in the liquid crystal clearance region EA formed by the convex WL2, it is possible to achieve the same effect as that in the first embodiment.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device which includes a first substrate and a second substrate arranged so as to face each other via a liquid crystal layer, the first substrate including video signal lines extending in a Y direction and arranged next to one another in an X direction and scanning signal lines extending in the X direction and arranged next to one another in the Y direction, pixel regions surrounded by the video signal lines and the scanning signal lines being formed in a matrix shape, the liquid crystal display device comprising:
a pair of wall-shaped first electrodes, which are formed along facing longer side edge portions of each pixel, at least a part of which overlaps with a first convex protruding from the first substrate on a side surface of the liquid crystal toward the side of the liquid crystal layer;
a linear second electrode which is formed in a pixel display portion interposed between the pair of first electrodes along an extending direction of the first electrodes;
a first capacitive electrode which is formed in at least one end portion of the pixel in a longer-side direction so as to be electrically connected to the first electrodes; and
a second capacitive electrode which is arranged so as to overlap with the first capacitive electrode via an insulating film and electrically connected to the second electrode,
wherein among the capacitive electrodes, a side edge portion of the first capacitive electrode formed in a level, which is closer to the liquid crystal layer, on the side of the pixel display portion is formed so as to be further retreated than a side edge portion of the second capacitive electrode formed in a level, which is further from the liquid crystal layer, on the side of the pixel display portion, and the second capacitive electrode is exposed from a retreating region of the first capacitive electrode in a planar view from the side of the liquid crystal layer, and
wherein a second convex is formed in a region overlapping with a corner and a side edge portion of the retreating region or a region between a side edge portion of the retreating region and the other capacitive electrode and extending in a shorter-side direction of the pixel.

2. The liquid crystal display device according to claim 1,
wherein each of the first electrodes is a pixel electrode to which a video signal is supplied via a thin film transistor, and
wherein the second electrode is a common electrode to which a common signal as a reference of the video signal is supplied.

3. The liquid crystal display device according to claim 2,
wherein the pixel display portion includes a first region between one of the pair of first electrodes and the second electrode and a second region between the other first electrode and the second electrode, and
wherein the retreating region is formed at an end portion of the second region.

4. The liquid crystal display device according to claim 3,
wherein the retreating region includes first side portions formed along a longer-side direction of the pixel and second side portions formed along a shorter-side direction, and
wherein among corners formed by the first side portions and the second side portions, at least a corner on a closer side to the first electrode is formed on a top vertex surface of the second convex.

5. The liquid crystal display device according to claim 1,
wherein the second substrate includes a linear third electrode formed at a position facing the second electrode via the liquid crystal layer.

6. The liquid crystal display device according to claim 1,
wherein each of the first electrodes is a common electrode to which a common signal as a reference of the video signal is supplied, and
wherein the second electrode is a pixel electrode to which the video signal is supplied via a thin film transistor.

7. The liquid crystal display device according to claim 6,
wherein the pixel display portion includes a first region between one of the pair of first electrodes and the second electrode and a second region between the other first electrode and the second electrode, and
wherein the retreating region is formed at an end portion of the first region.

8. The liquid crystal display device according to claim 7,
wherein the retreating region includes first side portions formed along a longer-side direction of the pixel and second side portions formed along a shorter-side direction, and
wherein among corners formed by the first side portions and the second side portions, at least a corner on a closer side to the second electrode is formed on a top vertex surface of the second convex.

9. The liquid crystal display device according to claim 1,
wherein the first electrode includes a side wall surface electrode formed on a side wall surface of the first convex formed so as to cross over a border between adjacent pixels and a planar electrode extending along a main surface of the first substrate from an end side of the side wall surface electrode on the side of the first substrate.

10. The liquid crystal display device according to claim 9,
wherein the first convex and the second convex are integrally formed as a C-shaped convex.

11. The liquid crystal display device according to claim 1,
wherein the pixel includes a region in which the first electrodes and the second electrode are inclined in a clockwise direction with respect to an initial orientation direction of the liquid crystal and a region in which the first electrodes and the second electrode are inclined in a counterclockwise direction with respect to the initial orientation direction of the liquid crystal.

12. A liquid crystal display device which includes a first substrate and a second substrate arranged so as to face each other via a liquid crystal layer, the first substrate including video signal lines extending in a Y direction and arranged next to one another in an X direction and scanning signal lines extending in the X direction and arranged next to one another in the Y direction, pixel regions surrounded by the video signal lines and the scanning signal lines being formed in a matrix shape, wherein the first substrate includes:
a pair of wall-shaped first electrodes, which are formed along facing longer side edge portions of each pixel, at least a part of which overlaps with a first convex protruding from the first substrate on a side surface of the liquid crystal toward the side of the liquid crystal layer;
a linear second electrode which is formed in a pixel display portion interposed between the pair of first electrodes along an extending direction of the first electrodes;
a first capacitive electrode which is formed in at least one end portion of the pixel in a longer-side direction so as to be electrically connected to the first electrodes; and
a second capacitive electrode which is arranged so as to overlap with the first capacitive electrode via an insulating film and electrically connected to the second electrode,
wherein the second substrate includes a linear third electrode formed at a position facing the second electrode via the liquid crystal layer; and
a fourth electrode formed in at least one end portion of the pixel in the longer-side direction and electrically connected to the third electrode,
wherein among the capacitive electrodes, side edge portions of the first capacitive electrode and the fourth electrode formed in a level, which is closer to the liquid crystal layer, on the side of the pixel display portion are formed so as to be further retreated than a side edge portion of the second capacitive electrode formed in a level, which is further from the liquid crystal layer, on the side of the pixel display portion, and
wherein the first substrate is provided with a second convex formed in a region overlapping with a corner and a side edge portion of the retreating region or a region between a side edge portion of the retreating region and the other capacitive electrode and extending in a shorter-side direction of the pixel.

13. The liquid crystal display device according to claim 12,
wherein the pixel includes a region in which the first electrodes, the second electrode, and the third electrode are inclined in a clockwise direction with respect to an initial orientation direction of the liquid crystal and a region in which the first electrodes, the second electrode, and the third electrode are inclined in a counterclockwise direction with respect to the initial orientation direction of the liquid crystal.
